(19) United States
(12) Patent Application Publication
(10) Pub. No.: US 2026/0304157 A1
(43) Pub. Date: Oct. 1, 2026

(54) COMMUNICATIONS FOR DATA COLLECTION CONFIGURATIONS

(71) Applicant: QUALCOMM Incorporated, San Diego, CA (US)

(72) Inventors: Punyaslok PURKAYASTHA, San Diego, CA (US); Rajeev KUMAR, San Diego, CA (US); Aziz GHOLMIEH, Del Mar, CA (US)

(21) Appl. No.: 19/569,980

(22) Filed: Mar. 17, 2026

Related U.S. Application Data
(60) Provisional application No. 63/778,364, filed on Mar. 26, 2025.

(51) Int. Cl. H04W 24/02; H04L 41/147

(52) U.S. Cl. CPC H04W 24/02; H04L 41/147

(57) ABSTRACT

Some examples of the techniques described herein may relate to data collection for training one or more artificial intelligence or machine learning (AI/ML) models to predict one or more measurements or measurement events. For example, signaling may be utilized for data collection for AI/ML model training. A trained AI/ML model may be utilized for beam management, channel state information (CSI) measurement prediction, CSI feedback prediction for a two-sided model, positioning enhancements, radio resource management (RRM) measurement prediction, or measurement event prediction, among other examples. Some approaches to RRM measurement prediction may include cell-level measurement prediction or beam-level measurement prediction. A user equipment (UE) may be configured by a source gNB with a set of cells to measure, a set of beams on each cell to measure, a set of cells for measurement prediction, or a set of beams on each cell for measurement prediction.

### CROSS REFERENCES

This Patent Application claims the benefit of U.S. Provisional Patent Application No. 63/778,364 by PURKAYASTHA et al., entitled “COMMUNICATIONS FOR DATA COLLECTION CONFIGURATIONS,” filed Mar. 26, 2025, and assigned to the assignee hereof. U.S. Provisional Patent Application No. 63/778,364 is expressly incorporated by reference herein in its entirety.

### INTRODUCTION

The following relates to wireless communication that pertains to communication for data collection configurations. Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method of wireless communication performed by a first network entity is described. The method may include transmitting capability information indicative of a capability of the first network entity to collect training data for one or more artificial intelligence or machine learning (AI/ML) models, where the capability information is indicative of the capability to collect training data for one or more prediction functionalities corresponding to the one or more AI/ML models, receiving configuration information indicative of one or more measurement objects for which the first network entity is to collect the training data for at least one prediction functionality of the one or more prediction functionalities, where the configuration information is based on the capability information, collecting the training data based on measurement of the one or more measurement objects indicated via the configuration information, and transmitting output information that is based on the training data.

A first network entity is described. The first network entity may include a processing system that includes processor circuitry and memory circuitry that stores code. The processing system may be configured to cause the first network entity to transmit capability information indicative of a capability of the first network entity to collect training data for one or more AI/ML models, where the capability information is indicative of the capability to collect training data for one or more prediction functionalities corresponding to the one or more AI/ML models, receive configuration information indicative of one or more measurement objects for which the first network entity is to collect the training data for at least one prediction functionality of the one or more prediction functionalities, where the configuration information is based on the capability information, collect the training data based on measurement of the one or more measurement objects indicated via the configuration information, and transmit output information that is based on the training data.

Another first network entity is described. The first network entity may include means for transmitting capability information indicative of a capability of the first network entity to collect training data for one or more AI/ML models, where the capability information is indicative of the capability to collect training data for one or more prediction functionalities corresponding to the one or more AI/ML models, means for receiving configuration information indicative of one or more measurement objects for which the first network entity is to collect the training data for at least one prediction functionality of the one or more prediction functionalities, where the configuration information is based on the capability information, means for collecting the training data based on measurement of the one or more measurement objects indicated via the configuration information, and means for transmitting output information that is based on the training data.

A non-transitory computer-readable medium storing code is described. The code may include instructions executable by one or more processors to transmit capability information indicative of a capability of the first network entity to collect training data for one or more AI/ML models, where the capability information is indicative of the capability to collect training data for one or more prediction functionalities corresponding to the one or more AI/ML models, receive configuration information indicative of one or more measurement objects for which the first network entity is to collect the training data for at least one prediction functionality of the one or more prediction functionalities, where the configuration information is based on the capability information, collect the training data based on measurement of the one or more measurement objects indicated via the configuration information, and transmit output information that is based on the training data.

Some examples of the method, first network entities, and non-transitory computer-readable medium described herein may further include operations, features, means, or instructions for receiving a request for the capability information, where transmission of the capability information may be based on the request for the capability information.

Some examples of the method, first network entities, and non-transitory computer-readable medium described herein may further include operations, features, means, or instructions for receiving candidate information indicative of candidate measurement objects and transmitting an indication of one or more selected candidate measurement objects from the candidate measurement objects, where the one or more measurement objects indicated in the configuration information may be based on the indication.

Some examples of the method, first network entities, and non-transitory computer-readable medium described herein may further include operations, features, means, or instructions for transmitting an indication that at least one measurement object of the one or more measurement objects cannot be measured.

Some examples of the method, first network entities, and non-transitory computer-readable medium described herein may further include operations, features, means, or instructions for receiving activation information indicative that data collection for the at least one prediction functionality may be activated.

Some examples of the method, first network entities, and non-transitory computer-readable medium described herein may further include operations, features, means, or instructions for transmitting a request to activate data collection for the at least one prediction functionality of the one or more prediction functionalities, where the request indicates one or more resources for measurement, the activation information indicates at least one resource of the one or more resources for measurement, and the activation information may be received based on the request to activate data collection.

Some examples of the method, first network entities, and non-transitory computer-readable medium described herein may further include operations, features, means, or instructions for receiving an indication that collection of the training data may be allowed for the at least one prediction functionality of the one or more prediction functionalities.

Some examples of the method, first network entities, and non-transitory computer-readable medium described herein may further include operations, features, means, or instructions for receiving AI/ML model information that may be indicative of an identifier that corresponds to at least one AI/ML model of the one or more AI/ML models and for which collection of the training data may be allowed.

Some examples of the method, first network entities, and non-transitory computer-readable medium described herein may further include operations, features, means, or instructions for transmitting a request to schedule data collection.

In some examples of the method, first network entities, and non-transitory computer-readable medium described herein, the one or more prediction functionalities include AI/ML-based radio resource management (RRM) measurement prediction, AI/ML-based cell measurement prediction, AI/ML-based beam measurement prediction, AI/ML-based measurement event prediction, AI/ML-based beam management prediction, AI/ML-based temporal measurement prediction, AI/ML-based spatial measurement prediction, AI/ML-based frequency measurement prediction, or any combination thereof.

Some examples of the method, first network entities, and non-transitory computer-readable medium described herein may further include operations, features, means, or instructions for receiving event configuration information, where the output information includes the event configuration information.

A method of wireless communication performed by a first network entity is described. The method may include receiving capability information indicative of a capability of a second network entity to collect training data for one or more AI/ML models, where the capability information is indicative of the capability to collect training data for one or more prediction functionalities corresponding to the one or more AI/ML models, transmitting configuration information indicative of one or more measurement objects for which the second network entity is to collect the training data for at least one prediction functionality of the one or more prediction functionalities, where the configuration information is based on the capability information, and receiving output information that is based on the training data.

A first network entity is described. The first network entity may include a processing system that includes processor circuitry and memory circuitry that stores code. The processing system may be configured to cause the first network entity to receive capability information indicative of a capability of a second network entity to collect training data for one or more AI/ML models, where the capability information is indicative of the capability to collect training data for one or more prediction functionalities corresponding to the one or more AI/ML models, transmit configuration information indicative of one or more measurement objects for which the second network entity is to collect the training data for at least one prediction functionality of the one or more prediction functionalities, where the configuration information is based on the capability information, and receive output information that is based on the training data.

Another first network entity is described. The first network entity may include means for receiving capability information indicative of a capability of a second network entity to collect training data for one or more AI/ML models, where the capability information is indicative of the capability to collect training data for one or more prediction functionalities corresponding to the one or more AI/ML models, means for transmitting configuration information indicative of one or more measurement objects for which the second network entity is to collect the training data for at least one prediction functionality of the one or more prediction functionalities, where the configuration information is based on the capability information, and means for receiving output information that is based on the training data.

A non-transitory computer-readable medium storing code is described. The code may include instructions executable by one or more processors to receive capability information indicative of a capability of a second network entity to collect training data for one or more AI/ML models, where the capability information is indicative of the capability to collect training data for one or more prediction functionalities corresponding to the one or more AI/ML models, transmit configuration information indicative of one or more measurement objects for which the second network entity is to collect the training data for at least one prediction functionality of the one or more prediction functionalities, where the configuration information is based on the capability information, and receive output information that is based on the training data.

Some examples of the method, first network entities, and non-transitory computer-readable medium described herein may further include operations, features, means, or instructions for transmitting a request for the capability information, where transmission of the capability information may be based on the request for the capability information.

Some examples of the method, first network entities, and non-transitory computer-readable medium described herein may further include operations, features, means, or instructions for transmitting candidate information indicative of candidate measurement objects and receiving an indication of one or more selected candidate measurement objects, where the one or more measurement objects indicated in the configuration information may be based on the indication.

Some examples of the method, first network entities, and non-transitory computer-readable medium described herein may further include operations, features, means, or instructions for receiving an indication that at least one measurement object of the one or more measurement objects cannot be measured.

Some examples of the method, first network entities, and non-transitory computer-readable medium described herein may further include operations, features, means, or instructions for transmitting activation information indicative that data collection for the at least one prediction functionality may be activated.

Some examples of the method, first network entities, and non-transitory computer-readable medium described herein may further include operations, features, means, or instructions for receiving a request to activate data collection for the at least one prediction functionality of the one or more prediction functionalities, where the request indicates one or more resources for measurement, the activation information indicates at least one resource of the one or more resources for measurement, and the activation information may be transmitted based on the request to activate data collection.

Some examples of the method, first network entities, and non-transitory computer-readable medium described herein may further include operations, features, means, or instructions for transmitting an indication that collection of the training data may be allowed for the at least one prediction functionality of the one or more prediction functionalities.

Some examples of the method, first network entities, and non-transitory computer-readable medium described herein may further include operations, features, means, or instructions for transmitting AI/ML model information that may be indicative of an identifier that corresponds to at least one AI/ML model of the one or more AI/ML models and for which collection of the training data may be allowed.

Some examples of the method, first network entities, and non-transitory computer-readable medium described herein may further include operations, features, means, or instructions for receiving a request to schedule data collection.

In some examples of the method, first network entities, and non-transitory computer-readable medium described herein, the one or more prediction functionalities include AI/ML-based RRM measurement prediction, AI/ML-based cell measurement prediction, AI/ML-based beam measurement prediction, AI/ML-based measurement event prediction, AI/ML-based beam management prediction, AI/ML-based temporal measurement prediction, AI/ML-based spatial measurement prediction, AI/ML-based frequency measurement prediction, or any combination thereof.

Some examples of the method, first network entities, and non-transitory computer-readable medium described herein may further include operations, features, means, or instructions for transmitting event configuration information, where the output information that may be based on the training data for the one or more AI/ML models includes the event configuration information.

### BRIEF DESCRIPTION OF THE DRAWINGS

FIG. 1 shows an example of a wireless communication system.

FIG. 2 shows an example of network entities that support communications for data collection configurations.

FIG. 3 shows an example of network entities that support communications for data collection configurations.

FIG. 4 shows an example of a process flow that supports communications for data collection configurations.

FIG. 5 shows an example of a process flow that supports communications for data collection configurations.

FIG. 6 shows an example of a node diagram that supports communications for data collection configurations.

FIG. 7 shows a block diagram of a processing system that supports communications for data collection configurations.

FIG. 8 shows a diagram of a system including a device that supports communications for data collection configurations.

FIG. 9 shows a block diagram of a processing system that supports communications for data collection configurations.

FIG. 10 shows a diagram of a system including a device that supports communications for data collection configurations.

FIGS. 11 through 14 show flowcharts illustrating methods that support communications for data collection configurations.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

Some wireless communication systems perform signal measurement to perform one or more operations, such as radio resource management (RRM), beam selection, or mobility, among other examples. In some cases, measuring multiple resources or cells may reduce available communication resources due to resources consumed for measurement.

Some examples of the techniques described herein may relate to data collection for training one or more AI/ML models to predict one or more measurements or measurement events (e.g., cell measurement for handover or cell switching). For example, signaling may be utilized for data collection for user equipment (UE)-side AI/ML model training or AI/ML model training on another device. A trained AI/ML model may be utilized for beam management, channel state information (CSI) measurement prediction, CSI feedback prediction for a two-sided model, positioning enhancements, RRM measurement prediction, or measurement event prediction, among other examples. Some approaches to RRM measurement prediction may include cell-level measurement prediction or layer 3 (L3) beam-level measurement prediction. The UE may be configured by a source gNB with a list of cells (e.g., a source cell and a set of candidate cells), a set of beams on each cell to measure, and another list of cells (e.g., source cell and a set of candidate cells) and a set of beams on each cell for measurement prediction.

Particular aspects of the subject matter described in this disclosure can be implemented to realize one or more of the following potential advantages. In some examples, by configuring signaling for data collection for training AI/ML models corresponding to one or more prediction functionalities, one or more AI/ML models may be trained to predict one or more measurements or measurement events, which may reduce signaling resource consumption or may increase measurement accuracy or performance.

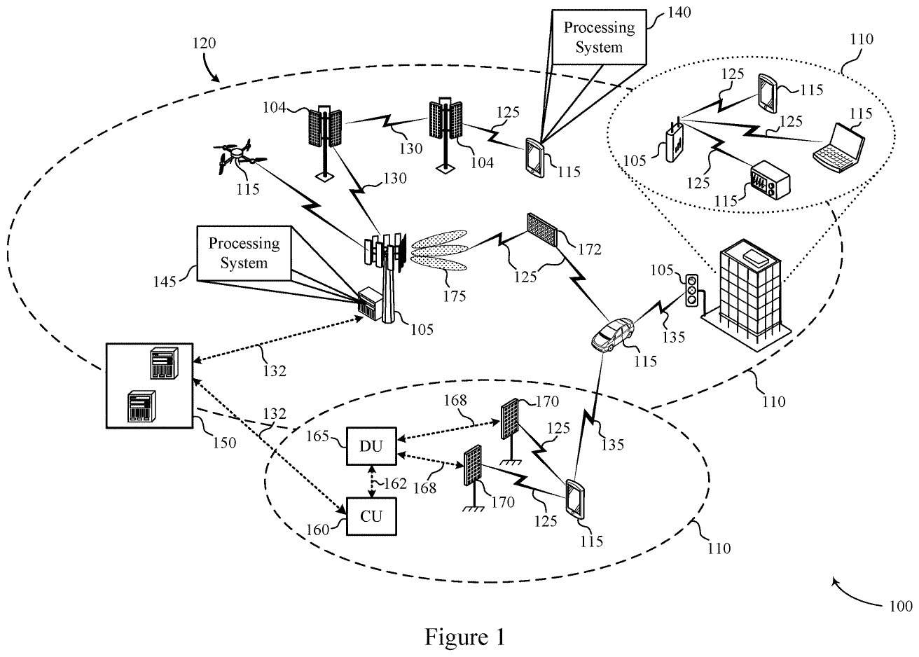

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a D2D communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for communications for data collection configurations. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support data collection configuration for training one or more AI/ML models corresponding to one or more prediction functionalities.

Some wireless communication systems perform signal measurement to perform one or more operations, such as RRM, beam selection, or mobility, among other examples. In some cases, measuring multiple resources or cells may reduce available communication resources due to resources consumed for measurement.

Some examples of the techniques described herein may relate to data collection for training one or more AI/ML models to predict one or more measurements or measurement events (e.g., cell measurement for handover or cell switching). For example, signaling may be utilized for data collection for UE-side AI/ML model training or AI/ML model training on another device. A trained AI/ML model may be utilized for beam management, CSI measurement prediction, CSI feedback prediction for a two-sided model, positioning enhancements, RRM measurement prediction, or measurement event prediction, among other examples. Some approaches to RRM measurement prediction may include cell-level measurement prediction or L3 beam-level measurement prediction. The UE may be configured by a source gNB with a list of cells (e.g., a source cell and a set of candidate cells), a set of beams on each cell to measure, and another list of cells (e.g., source cell and a set of candidate cells) and a set of beams on each cell for measurement prediction.

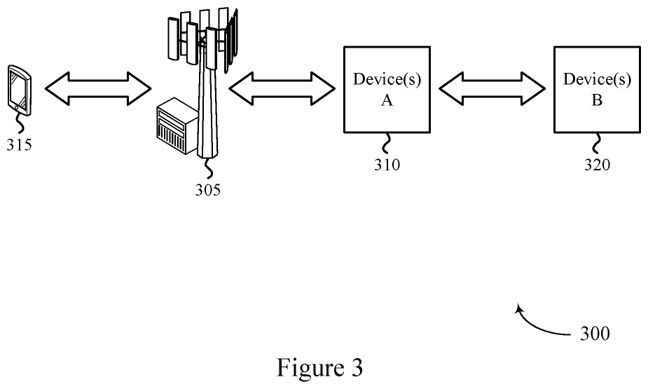

In some approaches, data collection may be performed for AI/ML model training (e.g., AI/ML model training for utilization at a UE), where the AI/ML model may be trained at a UE or a network device. Some aspects of the techniques described herein may include measurement configuration for training (e.g., UE-side training) or transfer or delivery of the collected data. Examples of data transfer and training are given with reference to FIG. 3. For measurement configuration for AI/ML model training (e.g., training for a UE-side AI/ML model), data collection related configuration(s) or associated identifier(s) may be included in a training data collection configuration. For data collection configuration AI/ML model training (e.g., training for a UE-side AI/ML model), a UE 115 may send a request for data collection (e.g., a request to start or stop data collection). In some approaches, a suggested data collection configuration or one or more associated identifiers or parameters may be provided to the network (e.g., network entity 105). The network may provide or release a data collection configuration (at any point in time, for instance), with or without a UE 115 request. One or more procedures may be performed for network control of the initiation or configuration for data collection. For instance, the network may determine when to start or stop data collection and send configuration information. Additionally, or alternatively, the network may configure whether the UE 115 is allowed to initiate a request for data collection (e.g., a start or stop indication).

In some approaches, data collection may be performed as a part of, or in association with, lifecycle management (LCM). For example, LCM may include one or more operations for controlling or managing AI/ML models. In some aspects, LCM may include one or more operations for training one or more AI/ML models, for updating one or more AI/ML models (e.g., for updating the training of one or more AI/ML models with training data), for monitoring one or more AI/ML models (e.g., monitoring an AI/ML model for accuracy or performance), for activating or deactivating one or more AI/ML models, for selecting one or more AI/ML models, for switching AI/ML models, or another operation(s) to control or manage one or more AI/ML models, or any combination thereof.

As described herein, a network entity (which may alternatively be referred to as an entity, a node, a network node, or a wireless entity) may be, be similar to, include, or be included in (e.g., be a component of) a base station (e.g., any base station described herein, including a disaggregated base station), a UE (e.g., any UE described herein), a reduced capability (RedCap) device, an enhanced reduced capability (eRedCap) device, an ambient internet-of-things (IoT) device, an energy harvesting (EH)-capable device, a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network entity may be a UE. As another example, a network entity may be a base station. As used herein, “network entity” may refer to an entity that is configured to operate in a network, such as the network described with reference to FIG. 1. For example, a “network entity” is not limited to an entity that is currently located in and/or currently operating in the network. Rather, a network entity may be any entity that is capable of communicating and/or operating in the network.

The adjectives “first,” “second,” “third,” and so on are used for contextual distinction between two or more of the modified noun in connection with a discussion and are not meant to be absolute modifiers that apply only to a certain respective entity throughout the entire document. For example, a network entity may be referred to as a “first network entity” in connection with one discussion and may be referred to as a “second network entity” in connection with another discussion, or vice versa. As an example, a first network entity may be configured to communicate with a second network entity or a third network entity. In one aspect of this example, the first network entity may be a UE, the second network entity may be a base station, and the third network entity may be a UE. In another aspect of this example, the first network entity may be a UE, the second network entity may be a base station, and the third network entity may be a base station. In yet other aspects of this example, the first, second, and third network entities may be different relative to these examples.

Similarly, reference to a UE, base station, apparatus, device, computing system, or the like may include disclosure of the UE, base station, apparatus, device, computing system, or the like being a network entity. For example, disclosure that a UE is configured to receive information from a base station also discloses that a first network entity is configured to receive information from a second network entity. Consistent with this disclosure, once a specific example is broadened in accordance with this disclosure (e.g., a UE is configured to receive information from a base station also discloses that a first network entity is configured to receive information from a second network entity), the broader example of the narrower example may be interpreted in the reverse, but in a broad open-ended way. In the example above where a UE is configured to receive information from a base station also discloses that a first network entity is configured to receive information from a second network entity, the first network entity may refer to a first UE, a first base station, a first apparatus, a first device, a first computing system, a first set of one or more one or more components, a first processing entity, or the like configured to receive the information; and the second network entity may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network entity may be described as being configured to transmit information to a second network entity. In this example and consistent with this disclosure, disclosure that the first network entity is configured to transmit information to the second network entity includes disclosure that the first network entity is configured to provide, send, output, communicate, or transmit information to the second network entity. Similarly, in this example and consistent with this disclosure, disclosure that the first network entity is configured to transmit information to the second network entity includes disclosure that the second network entity is configured to receive, obtain, or decode the information that is provided, sent, output, communicated, or transmitted by the first network entity.

As shown, the network entity (e.g., network entity 105) may include a processing system 145. Similarly, the network entity (e.g., UE 115) may include a processing system 140. A processing system may include one or more components (or subcomponents), such as one or more components described herein. For example, a respective component of the one or more components may be, be similar to, include, or be included in at least one memory, at least one communication interface, or at least one processor. For example, a processing system may include one or more components. In such an example, the one or more components may include a first component, a second component, and a third component. In this example, the first component may be coupled to a second component and a third component. In this example, the first component may be at least one processor, the second component may be a communication interface, and the third component may be at least one memory. A processing system may generally be a system including one or more components that may perform one or more functions, such as any function or combination of functions described herein. For example, one or more components may receive input information (e.g., any information that is an input, such as a signal, any digital information, or any other information), one or more components may process the input information to generate output information (e.g., any information that is an output, such as a signal or any other information), one or more components may perform any function as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, a network entity described herein). For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a network entity described herein may interface with one or more other components of the network entity, may process information received from one or more other components (such as input information), or may output information to one or more other components. For example, a processing system may include a first component configured to interface with one or more other components of the network entity to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip or modem of the network entity may include a processing system. The processing system may include a first communication interface to receive or obtain information, and a second communication interface to output, transmit, or provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

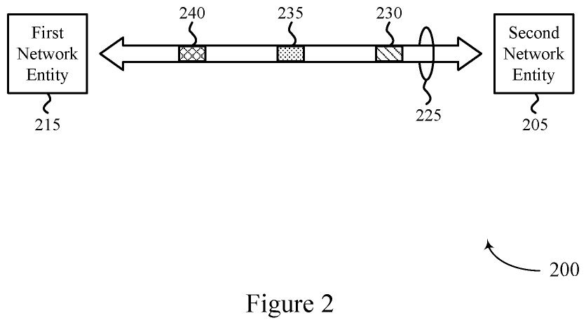

FIG. 2 shows an example of network entities 200 that supports communications for data collection configurations. One or more of the network entities 200 may be included in the wireless communication system 100 described with reference to FIG. 1. The network entities 200 may include a second network entity 205 and a first network entity 215. The second network entity 205 may be an example of a network entity 105 (e.g., gNB, transmission-reception point (TRP), base station, or network node, among other examples), RU 170, DU 165, CU 160, or UE 115 described with reference to FIG. 1, any combination thereof, or another device. The first network entity 215 may be an example of a network entity 105 (e.g., gNB, TRP, base station, or network node, among other examples), RU 170, DU 165, CU 160, or UE 115 described with reference to FIG. 1, any combination thereof, or another device.

The first network entity 215 may communicate with the second network entity 205 using a link 225. The link 225 may be an example of a communication link 125, a communication link 135, a backhaul link 132, a midhaul link 162, a fronthaul link 168, a wired link, a wireless link described with reference to FIG. 1, another link (e.g., sidelink, D2D communication link, or V2X link, among other examples), or any combination thereof. The link 225 may include a uni-directional or bi-directional link that enables uplink, downlink, sidelink, other communications, or a combination thereof. For example, the first network entity 215 may transmit one or more uplink transmissions, such as uplink control signals or uplink data signals, to the second network entity 205 using the link 225, or the second network entity 205 may transmit one or more downlink transmissions, such as downlink control signals or downlink data signals, to the first network entity 215 using the link 225. Additionally, or alternatively, the second network entity 205 may transmit one or more uplink transmissions, such as uplink control signals or uplink data signals, to the first network entity 215 using the link 225, or the first network entity 215 may transmit one or more downlink transmissions, such as downlink control signals or downlink data signals, to the second network entity 205 using the link 225.

The first network entity 215 may output (e.g., transmit), or the second network entity 205 may obtain (e.g., receive), capability information 230 indicative of a capability of the first network entity 215 to collect training data for one or more AI/ML models. The capability information 230 may be indicative of the capability to collect training data for one or more prediction functionalities corresponding to the one or more AI/ML models.

A prediction functionality may be a functionality to predict (e.g., calculate or infer) one or more values (e.g., measurements, events, labels, or classifications, among other examples) via one or more AI/ML models. As used herein, the term “predict” and variations thereof may refer to past, current, or future values. Additionally, or alternatively, “predict” and variations thereof may refer to temporal prediction (e.g., prediction of a value for a past time, a current time, or a future time), frequency prediction (e.g., prediction of a value for one or more frequencies), or spatial prediction (e.g., prediction of a value for one or more locations or areas, such as beam angles, beam widths, or beam coverage), or any combination thereof, among other examples. For cell-level RRM prediction, temporal domain prediction may include prediction (e.g., by a UE), for a serving cell or a candidate cell, of one or more measurements at one or more specified time instances. For cell-level RRM prediction, frequency domain prediction may include prediction (e.g., by a UE) of one or more measurements for a candidate cell on a different frequency (than the cells on which a UE performs measurements, for instance). For cell-level RRM prediction, spatial domain prediction may include prediction (e.g., by a UE) of one or more measurements for a serving cell or a candidate cell by measuring a subset of configured SSBs, or for a candidate cell, on which measurements are not performed (by the UE, for instance), based on one or more measurements of one or more other cells. For beam-level RRM prediction, temporal domain prediction may include prediction (e.g., by a UE), for one or more beams of a serving cell or a candidate cell, of one or more L3 beam-level measurements at one or more specified time instances. For beam-level RRM prediction, frequency domain prediction may include prediction (e.g., by a UE) of one or more L3 beam-level measurements of one or more beams for a candidate cell on a different frequency (than the cells on which UE performs measurements, for instance). For beam-level RRM prediction, spatial domain prediction may include prediction (e.g., by a UE) of one or more L3 beam-level measurements for one or more beams of a serving cell or a candidate cell (on which measurements are not performed by the UE, for instance) based on one or more measurements of other beams on the same cell or other cells. In some examples, the first network entity 215 (e.g., UE) may indicate one or more capabilities for supporting a prediction functionality (e.g., a UE feature), such as AI/ML for RRM prediction, AI/ML for event prediction, or AI/ML for beam management, among other examples. Additionally, or alternatively, the first network entity 215 may indicate one or more capabilities for supporting data collection for AI/ML model training (e.g., data collection for an AI/ML model to be utilized on the UE-side) per prediction functionality (e.g., AI/ML for RRM prediction, AI/ML for event prediction, or AI/ML for beam management, among other examples).

In some aspects, the one or more prediction functionalities may include AI/ML-based RRM measurement prediction, AI/ML-based cell measurement prediction, AI/ML-based beam measurement prediction, AI/ML-based measurement event prediction, AI/ML-based beam management prediction, AI/ML-based temporal measurement prediction, AI/ML-based spatial measurement prediction, AI/ML-based frequency measurement prediction, or any combination thereof. For instance, an AI/ML model may be trained to perform frequency measurement prediction, where the AI/ML model may utilize one or more measurements at one or more first frequencies to predict a measurement(s) at one or more second frequencies (e.g., different frequency(ies)). Additionally, or alternatively, an AI/ML model may be trained to perform spatial measurement prediction, where the AI/ML model may utilize one or more measurements corresponding to one or more first locations to predict one or more measurements corresponding to one or more second locations (e.g., different location(s)). In some approaches, spatial domain prediction may include prediction (e.g., by a UE) of one or more measurements for a serving cell or a candidate cell by measuring a subset of configured SSBs, or for a candidate cell, on which measurements are not performed (by the UE, for instance), based on one or more measurements of one or more other cells. Additionally, or alternatively, an AI/ML model may be trained to perform temporal measurement prediction, where the AI/ML model may utilize one or more measurement at one or more first times to predict one or more measurement at one or more second times (e.g., different time(s)). Additionally, or alternatively, an AI/ML model may be trained to perform beam management prediction, where the AI/ML model may utilize one or more measurements to predict one or more beam management events (e.g., beam switching or a change in beamforming, among other examples). Additionally, or alternatively, an AI/ML model may be trained to perform beam measurement prediction, where the AI/ML model may utilize one or more first beam measurements to predict one or more second beam measurements (e.g., beam measurement(s) for a different beam(s), among other examples). Additionally, or alternatively, an AI/ML model may be trained to perform measurement event prediction, where the AI/ML model may utilize one or more measurements to predict one or more measurement events (e.g., measurement event configuration for triggering for handover or cell switching, among other examples). Additionally, or alternatively, an AI/ML model may be trained to perform cell measurement prediction, where the AI/ML model may utilize one or more measurements to predict one or more cell measurements events (e.g., measurement(s) corresponding to different cells or measurement(s) at a cell level, among other examples). Additionally, or alternatively, an AI/ML model may be trained to perform RRM measurement prediction, where the AI/ML model may utilize one or more measurements to predict one or more RRM measurements (e.g., transmit power measurement(s), cell measurement(s), or beam measurement(s), among other examples).

In some examples, the capability information 230 may be indicative of one or more capabilities to collect training data that correspond to the one or more prediction functionalities. For instance, the capability information 230 may include one or more indicators (e.g., one or more explicit or implicit indicators, such as one or more bits, codes, parameters, indices, signaling patterns, or signal timing, among other examples) that indicate or correspond to the one or more prediction functionalities for which the first network entity 215 is capable of collecting training data. In some aspects, different prediction functionalities or AI/ML models may demand different types of training data for training or functioning. For instance, training data for an AI/ML model for temporal prediction may include a first measurement at a first time and a second measurement at a second time. Training data for an AI/ML model for frequency prediction may include a first measurement at a first frequency and a second measurement at a second frequency. Training data for an AI/ML model for event prediction may include a measurement and an indicator of whether an event occurred (e.g., whether handover, a cell switch, or a beam switch occurred or was triggered). The capability information 230 may indicate whether the first network entity 215 is capable of performing measurements for one or more of the prediction functionalities or AI/ML models. The capability information 230 may enable the second network entity 205 to control, coordinate, or configure one or more measurement objects or resources for data collection corresponding to one or more prediction functionalities or AI/ML models.

In some aspects, the capability information 230 may be indicative of one or more measurement capabilities. For instance, the capability information 230 may indicate one or more quantities or threshold quantities of cells (e.g., minimum quantity or maximum quantity of cells) that the first network entity 215 (e.g., UE) supports for measurement for data collection. Additionally, or alternatively, the capability information 230 may indicate one or more quantities or threshold quantities of beams (e.g., minimum quantity or maximum quantity of beams per cell or across one, some, or all cells) that the first network entity 215 (e.g., UE) supports for measurement for data collection.

In some approaches, the capability information 230 may be signaled via control information (e.g., RRC signaling, medium access control-control element (MAC-CE) signaling, UCI, or DCI, among other examples). In some aspects, the capability information 230 may be communicated (e.g., output, transmitted, obtained, or received) without a request or may be communicated in response to a request (e.g., a capability enquiry). For instance, the second network entity 205 may output (e.g., transmit), or the first network entity 215 may obtain (e.g., receive), receive a request for the capability information 230. The communication (e.g., outputting, transmission, obtaining, or reception) of the capability information 230 may be based on the request for the capability information 230. For instance, the first network entity 215 may transmit the capability information 230 in response to a request for the capability information 230 from the second network entity 205.

The second network entity 205 may output (e.g., transmit), or the first network entity 215 may obtain (e.g., receive), configuration information 235 indicative of one or more measurement objects for which the first network entity 215 is to collect the training data for at least one prediction functionality of the one or more prediction functionalities. A measurement object may be a resource or a combination of resources that may be utilized for measurement. For instance, a measurement object may specify one or more time resources (e.g., period(s), slot(s), start time(s), stop time(s), or length(s), among other examples), one or more frequency resources (e.g., frequency(ies), frequency band(s), carrier(s), or subcarrier(s), among other examples), one or more spatial resources (e.g., area(s), sector(s), zone(s), angular range(s), altitude(s), region(s), county(ies), state(s), province(s), or country(ies), among other examples), one or more cells, one or more beams, one or more measurement gaps, or any combination thereof, among other examples. In some examples, the configuration information 235 may indicate the measurement object(s) via one or more indexes, parameters, quantities, or values.

In some examples, the configuration information 235 may be indicative of one or more measurement objects or resources for collection of training data that correspond to the one or more prediction functionalities. For instance, the configuration information 235 may include one or more indicators (e.g., one or more explicit or implicit indicators, such as one or more bits, codes, parameters, indices, signaling patterns, or signal timing, among other examples) that indicate or correspond to the one or more prediction functionalities for which the first network entity 215 is to collect training data. In some aspects, different prediction functionalities or AI/ML models may demand different measurement objects or resources for training data collection. For instance, training data for an AI/ML model for temporal prediction may include a first measurement at a first time and a second measurement at a second time. Training data for an AI/ML model for frequency prediction may include a first measurement at a first frequency and a second measurement at a second frequency. Training data for an AI/ML model for event prediction may include a measurement and an indicator of whether an event occurred (e.g., whether handover, a cell switch, or a beam switch occurred or was triggered). The configuration information 235 may indicate one or more measurement objects for training data collection for one or more of the prediction functionalities or AI/ML models. The configuration information 235 may enable the first network entity 215 to measure one or more signals (e.g., reference signals, CSI-RSs, SSBs, interfering signals, signals from different cells, signals from different beams, signals at different frequencies, or signals at different times) for data collection corresponding to one or more prediction functionalities or AI/ML models. For instance, the second network entity 205 (e.g., network) may provide the first network entity 215 (e.g., UE) with configuration information to perform data collection for AI/ML model training (for utilization at a UE, for instance). The configuration information 235 may correspond to, or may be associated with, one or more prediction purposes or functionalities (e.g., cell-level measurement prediction, or layer 3 (L3) beam-level measurement prediction, among other examples).

In some approaches, the configuration information 235 may be signaled via control information (e.g., RRC signaling, an RRC reconfiguration message, MAC-CE signaling, UCI, or DCI, among other examples). In some aspects, the configuration information 235 may be based on the capability information 230. For instance, the second network entity 205 may determine, select, or allocate one or more measurement objects in accordance with the configuration information 235. In some approaches, the configuration information 235 may indicate one or more measurement objects corresponding to a subset or all of the prediction functionalities indicated by the capability information 230.

The first network entity 215 may collect the training data based on measurement of the one or more measurement objects indicated via the configuration information 235. For instance, the first network entity 215 may measure one or more signals on the one or more measurement objects. In some aspects, the first network entity 215 may measure one or more reference signals (e.g., reference signals, CSI-RSs, SSBs, interfering signals, signals from different cells, signals from different beams, signals at different frequencies, or signals at different times) via the one or more measurement objects or via one or more resources corresponding to the measurement object(s).

In some examples, training data may include one or more measurements of one or more signals obtained or received by the first network entity 215 from the second network entity 205, from another device(s), or from any combination thereof. Additionally, or alternatively, training data may include input data (e.g., data to be input into an AI/ML model), output data (e.g., ground truth data, label data, or target data), or a combination thereof. For example, the training data may include “input” measurements to be input to an AI/ML model during training or “output” measurements to be compared with an output of an AI/ML model. During training, for instance, input data may be input to an AI/ML model, which may produce one or more outputs. The one or more outputs may be compared with the output data or output measurements to determine a difference (e.g., error) or a cost via a cost function. One or more weights of the AI/ML model may be adjusted to reduce the difference or cost between the AI/ML model output and the collected output data or output measurements (e.g., ground truth).

The first network entity 215 may output (e.g., transmit), or the second network entity 205 may obtain (e.g., receive), output information 240 that is based on the training data. For instance, the output information 240 may include the training data, may include a portion (e.g., a selected portion) of the training data, may include an indication of some or all of the training data, may indicate or include one or more outputs of an AI/ML model that is trained based on the training data, or may indicate or include one or more activation values or node values (e.g., one or more internal or node values within the AI/ML model before an output layer), among other examples.

In some approaches, the first network entity 215 may perform AI/ML model training based on the training data. The output information 240 may indicate one or more values output from the AI/ML model that has been trained based on the training data. For instance, the first network entity 215 may execute the AI/ML model based on one or more measurements to produce one or more predicted measurements or events in accordance with one or more of the prediction functionalities (for which the AI/ML model is trained to perform). Additionally, or alternatively, the output information 240 may indicate some or all of the training data. The second network entity 205 may utilize the training data to perform AI/ML model training, or may send the training data or an indication of the training data to another device (e.g., a server, a core network entity, a network data analytics function (NWDAF), or an access and mobility management function (AMF), among other examples). For instance, the second network entity 205 may train one or more AI/ML models to perform one or more of the prediction functionalities based on the training data. The trained AI/ML model(s) may be communicated (e.g., deployed) to the first network entity 215 or one or more other devices (e.g., UEs) for performance of the one or more prediction functionalities.

In some approaches, the trained AI/ML model may be utilized to reduce resource consumption or to improve measurement accuracy. In some examples, an AI/ML model may be utilized at the first network entity 215 or one or more other devices (e.g., UEs) to predict one or more measurements with reduced measurement gaps or allocated resources. For instance, the first network entity 215 may measure a first signal during a first measurement gap or via first resources, and may utilize an AI/ML model to predict a measurement for another measurement gap or for second resources that are not allocated or utilized to perform an actual measurement. In another example, the first network entity 215 may measure a first signal from a first cell or first beam, and may utilize an AI/ML model to predict a measurement for a second cell or second beam that is unavailable (e.g., blocked or obstructed) for measurement, for which resources are not allocated for measurement, or that is not actually measured.

In some examples, the second network entity 205 may output (e.g., transmit), or the first network entity 215 may obtain (e.g., receive), candidate information indicative of one or more candidate measurement objects. For instance, the second network entity 205 (e.g., network) may indicate to the first network entity 215 (e.g., a UE) one or more (e.g., a range) of configuration options for data collection. In some aspects, the one or more candidate measurement objects may include or indicate a set (e.g., list) of measurement configurations (e.g., measObjects for AI/ML based RRM prediction or measObjects for AI/ML based event prediction, among other examples) that the first network entity 215 may perform measurements on, or a set (e.g., list) of measurement configurations (e.g., measObjects for AI/ML based RRM prediction or measObjects AI/ML based event prediction, among other examples) on which the first network entity 215 may perform measurement prediction. In some examples, the one or more candidate measurement objects (e.g., measObject(s)) may include or indicate one or more frequencies, a set (e.g., list) of one or more cells on each frequency (e.g., source cell or candidate cell(s)), or one or more reference signal configurations (e.g., SSB or CSI-RS configuration, among other examples) for each cell. In some aspects, the candidate information may be communicated (e.g., output, transmitted, obtained, or received) via control signaling (e.g., RRC signaling, RRC reconfiguration signaling, MAC-CE signaling, DCI, or UCI, among other examples).

The first network entity 215 may select one or more of the candidate measurement objects. For example, the first network entity 215 may select one or more of the candidate measurement objects based on available processing bandwidth, available memory, operating state (e.g., awake or sleep state), or available power (e.g., remaining battery), among other examples. The first network entity 215 may output (e.g., transmit), or the second network entity 205 may obtain (e.g., receive), an indication of one or more selected candidate measurement objects from the candidate measurement objects. For instance, the first network entity 215 (e.g., UE) may indicate to the second network entity 205 (e.g., network) a selection of the measurement configuration (e.g., one or measObjects for AI/ML based RRM prediction or one or more measObjects for AI/ML based event prediction, among other examples) on which to perform measurements. Additionally, or alternatively, the first network entity 215 (e.g., UE) may indicate to the second network entity 205 (e.g., network) a selection of the measurement configuration (e.g., one or more measObjects for AI/ML based RRM prediction or one or more measObjects for AI/ML based event prediction, among other examples) on which to perform prediction. In some approaches, the first network entity 215 (e.g., UE) may indicate one or target, candidate, or suggested measurement gap patterns. In some aspects, the target, candidate or suggested measurement gap pattern(s) may be indicated in a message that also indicates the one or more selected candidate measurement objects. In some approaches, the selected candidate measurement object(s) or measurement gap pattern(s) may be communicated (e.g., output, transmitted, obtained, or received) via UE assistance information (UAI).

In some cases, the one or more measurement objects indicated in the configuration information 235 may be based on the indication. For instance, the second network entity 205 may allocate the one or more measurement objects as a subset or all of the selected candidate measurement object(s).

In some approaches, the first network entity 215 may output (e.g., transmit), or the second network entity 205 may obtain (e.g., receive), an indication that at least one measurement object of the one or more measurement objects cannot be measured. For instance, the first network entity 215 (e.g., UE) may indicate to the second network entity 205 (e.g., network) if one or more measurement objects (e.g., measObject(s)) for data collection for AI/ML model training (for a UE-side AI/ML model, for instance) is not suitable or if the first network entity 215 is currently unable to measure a reference signal based on the configuration for data collection for the AI/ML model training. For instance, if the first network entity 215 is currently unable to measure a reference signal on one or more configurated measurement objects, the first network entity 215 may send an indication to the second network entity 205. In some approaches, the indication may also indicate a reason for the rejection or failure to measure (e.g., a lack of resources, available processing bandwidth is below a threshold, available memory is below a threshold, or available power is below a threshold, among other examples).

In some examples, the second network entity 205 may output (e.g., transmit), or the first network entity 215 may obtain (e.g., receive), an indication that collection of the training data is allowed for the at least one prediction functionality of the one or more prediction functionalities. For instance, the second network entity 205 (e.g., network) may indicate in a message (e.g., an RRC reconfiguration message), whether data collection is allowed for the prediction functionality (e.g., UE feature) or not.

In some aspects, the second network entity 205 may output (e.g., transmit), or the first network entity 215 may obtain (e.g., receive), AI/ML model information that is indicative of an identifier that corresponds to at least one AI/ML model of the one or more AI/ML models and for which collection of the training data is allowed. Additionally, or alternatively, the second network entity 205 (e.g., network) may transmit, or the first network entity 215 may obtain (e.g., receive) an identifier (e.g., an associated identifier) corresponding to a set of cells (e.g., an identifier corresponding to a list of cells, a local topology, or one or more network settings), for which the configuration applies. Some examples of the identifier (e.g., associated identifier) may include one or more serving cell identifiers or one or more on-off indicators of cells. The identifier may be utilized to maintain or ensure an alignment or correspondence between data collection or training configuration and an inference or prediction configuration.

In some approaches, the first network entity 215 may output (e.g., transmit), or the second network entity 205 may obtain (e.g., receive), a request to schedule data collection. For instance, the first network entity 215 (e.g., UE) may initiate performing data collection for a point of time (e.g., for a target time). The first network entity 215 (e.g., UE) may indicate the request to schedule data collection in a message (e.g., RRC UAI, RRC reconfiguration complete, RRC resume complete, or MAC-CE, among other examples) to the second network entity 205 (e.g., network). In some aspects, the first network entity 215 may additionally, or alternatively, transmit an indication of one or more quantities or threshold quantities of cells (e.g., minimum quantity or maximum quantity of cells) that the first network entity 215 (e.g., UE) requests (e.g., targets or suggests) for configuration from the second network entity 205 for measurement for data collection. Additionally, or alternatively, the first network entity 215 may transmit an indication of one or more quantities or threshold quantities of beams (e.g., minimum quantity or maximum quantity of beams per cell or across one, some, or all cells) that the first network entity 215 (e.g., UE) requests (e.g., targets or suggests) for configuration from the second network entity 205 for measurement for data collection.

In some examples, the second network entity 205 may output (e.g., transmit), or the first network entity 215 may obtain (e.g., receive) activation information indicative that data collection for the at least one prediction functionality is activated or deactivated. The activation information may be communicated (e.g., output, transmitted, obtain, or received) independently or in response to a request. For instance, the first network entity 215 may output (e.g., transmit), or the second network entity 205 may obtain (e.g., receive), a request to activate or deactivate data collection for the at least one prediction functionality of the one or more prediction functionalities. The request may indicate one or more resources for measurement. The activation information may be communicated (e.g., output, transmitted, obtained, or received) based on the request to activate or deactivate data collection. For example, the activation information may indicate at least one resource of the one or more resources for measurement. In some aspects, for example, the second network entity 205 (e.g., network) may signal the first network entity 215 (e.g., UE) to activate or deactivate data collection per prediction functionality (e.g., UE feature). The second network entity 205 (e.g., network) may activate or deactivate data collection at the first network entity 215 (e.g., UE) autonomously or independently, or based on receiving a request from the first network entity 215. In the request, the first network entity 215 (e.g., UE) may request transmission on a set (e.g., list) of reference signal resources for performing measurements. For instance, a set of reference signal resources may be requested for each configured cell (e.g., serving or candidate cell). If the reference signal resources belong to a candidate cell on another network entity (e.g., gNB), the second network entity 205 may forward the request or signaling to the other network entity (over an Xn interface or connection, for example), or may receive a response message over the Xn interface or connection from another network entity indicating a set (e.g., list) of reference signal resources for one or more candidate cells.

Some examples of the techniques described herein may relate to data collection for event (e.g., measurement event) prediction. One or more types of measurement event prediction may be performed. Indirect event prediction may utilize measurement prediction (e.g., RRM measurement prediction, cell measurement prediction, or beam measurement prediction) with an event configuration to predict the occurrence of an event. For instance, an AI/ML model may be utilized to predict one or more measurements, which may be utilized with an event configuration to predict whether the event will occur. Direct event prediction may utilize an AI/ML model to predict (e.g., directly predict) the occurrence of an event. For instance, an AI/ML model may predict the occurrence of an event (or a probability of an occurrence of an event). For direct event prediction, the input to the AI/ML model may include one or more measurements (e.g., RRM measurements, cell measurements, beam measurements, or any combination thereof). One or more other inputs (e.g., UE location) may be utilized (which may vary based on network entity or UE implementation, for instance).

In some approaches, measurement event prediction may utilize data collection for measurement prediction (e.g., RRM measurement prediction), as indirect and direct event prediction may utilize RRM measurements as input to an AI/ML model. In some aspects for event prediction (e.g., measurement event prediction), the second network entity 205 (e.g., network) may signal or indicate one or more event configurations to the first network entity 215 (e.g., UE). In some aspects, the one or more event configurations may be indicated explicitly or implicitly. In some examples, the one or more event configurations may indicate one or more events (e.g., a measurement event for handover, for cell switching, for beam switching, or for frequency switching, such as an A3 event, among other examples) for one or more cell pairs (e.g., a pair of a source cell and a candidate cell), one or more thresholds (e.g., event trigger threshold(s)), one or more times to trigger, or one or more hystereses for one or more events.

In some aspects, the second network entity 205 may output (e.g., transmit), or the first network entity 215 may obtain (e.g., receive), event configuration information. In some approaches, the event configuration information may be utilized (e.g., as an input) for AI/ML model training at the first network entity 215. Additionally, or alternatively, the output information 240 (e.g., that is based on the training data for the one or more AI/ML models) may include the event configuration information. For instance, the first network entity 215 (e.g., UE) may forward the event configuration information to the second network entity 205 (e.g., server) for training purposes. Event configuration information (e.g., event configurations) may be utilized for indirect event prediction, or may be utilized for direct event prediction.

In some approaches, some operations or signaling may be combined, established, or specified (e.g., to reduce signaling or to optimize one or more procedural aspects). In some examples of signaling, the second network entity 205 (e.g., network) may indicate to the first network entity 215 (e.g., to a UE via RRC reconfiguration) whether data collection is allowed or not for one or more prediction functionalities (e.g., UE features) or a range (e.g., full range) of configuration options may be signaled for data collection (e.g., a list of measObjects that may be the input and the output of the AI/ML model). In other examples, one or more aspects or operational parameters may be established offline for the first network entity 215 (e.g., UE) or the second network entity 205 (e.g., network) before a signaling procedure. For instance, data collection may be established as allowed or not for one or more of the prediction functionalities (e.g., UE feature(s)). In that case, the range of configuration options for data collection may be signaled, while signaling to indicate whether data collection is allowed may be avoided.

In some approaches, the first network entity 215 (e.g., UE) may indicate to the second network entity 205 (e.g., network) a request to perform data collection, a selection of the measurement objects (e.g., measObjects) to measure and predict, or target or suggested measurement gap patterns (via one message, UAI, or MAC-CE, for instance). Additionally, or alternatively, the second network entity 205 (e.g., network) may provide the first network entity 215 (e.g., UE) with configuration information (via RRC reconfiguration, for example) to perform data collection.

In some approaches, the first network entity 215 (e.g., UE) may indicate one or more of the following in capability information (e.g., UE capabilities) and/or UAI: a lower and/or upper (e.g., minimum and/or maximum) quantity(ies) of cells that the first network entity 215 (e.g., UE) may support for measurements for data collection, and/or a lower and/or upper (e.g., minimum and/or maximum) quantity(ies) of beams per cell or across one or more (e.g., all) cells the first network entity 215 may support for measurements for data collection. In some approaches, a network entity (e.g., the second network entity 205) or a network may additionally, or alternatively, provide an associated identifier (ID) corresponding to a list of cells (e.g., a local topology), for which the configuration applies. Examples of associated ID may include a serving cell ID and/or an on-off indicator(s) of one or more cells. In some aspects, a network entity (e.g., the second network entity 205) or a network may additionally, or alternatively, indicate to the first network entity 215 (e.g., UE) a set (e.g., list) of one or more (e.g., all) measurement configurations that the first network entity 215 may perform measurements on, and/or a set (e.g., list) of one or more (e.g., all) measurement configurations on which the first network entity 215 may perform measurement prediction. In some aspects, the first network entity 215 (e.g., UE) may indicate to a network entity (e.g., the second network entity 205 or a network) its selection of the measurement configuration to perform measurements on, and/or a measurement configuration(s) to perform prediction on. The first network entity 215 (e.g., UE) may additionally, or alternatively, provide a recommendation for one or more measurement gap patterns in the message. In some aspects, the first network entity 215 (e.g., UE) may indicate to a network entity (e.g., the second network entity 205 or a network) whether one or more measurement objects (e.g., measObjects) for data collection for first network entity-side model training is or are not suitable.

FIG. 3 shows an example of network entities 300 that supports communications for data collection configurations. The network entities 300 may include a UE(s) 315, a network node(s) 305, a device(s) A 310, or a device(s) B 320. In some approaches, a UE(s) 315 may be an example of the UE 115 described with reference to FIG. 1, or the first network entity 215 described with reference to FIG. 2. The network node 305 (e.g., gNB, TRP, or RU, among other examples) may be an example of a network entity 105 described with reference to FIG. 1, the second network entity 205 described with reference to FIG. 2, or another device. The network node 305 may be included in a mobile network operator (MNO) cloud (e.g., network) or in a RAN. A device A 310 (e.g., core network function, AMF, NWDAF, operations, administration, and maintenance (OAM) device, server(s), data collection server(s), or UE vendor-specific data collection server(s), among other examples) may be an example of a network entity 105 described with reference to FIG. 1, the second network entity 205 described with reference to FIG. 2, or another device(s). The device(s) A 310 may be included in an MNO cloud. A device B 320 (e.g., server(s)) may be an example of a network entity 105 described with reference to FIG. 1, the second network entity 205 described with reference to FIG. 2, or another device(s). The device(s) B 320 may be included in a UE vendor cloud. In some examples, the device(s) A 310 or the device(s) B 320 may communicate with the UE(s) 315 via the network node(s) 305. In some examples, the device(s) A 310 may be included within a MNO cloud, or the device(s) B 320 may be outside of an MNO cloud. In some aspects, AI/ML model training may be performed at the UE(s) 315, within an MNO cloud (e.g., network node(s) 305 or device(s) A 310), in a UE vendor cloud (e.g., device(s) B 320), or in a combination thereof. The UE(s) 315, network node(s) 305, device(s) A 310, or device(s) B 320 may perform one or more of the operations described with reference to FIG. 2.

In some examples of the techniques described herein, one or more approaches may be utilized for data collection or AI/ML training for prediction functionality. Various approaches for data collection for training an AI/ML model (e.g., for an AI/ML on a UE-side) are described. In some aspects, the UE(s) 315 may include one or more field UEs. The UE(s) 315 may perform data collection in collaboration with one or more operator devices (e.g., device(s) A 310). For instance, the UE(s) 315 may perform one or more of the operations described with reference to FIG. 2 to collect training data. In some approaches, data collection parameters may be authorized by the one or more operator devices (e.g., device(s) A 310).

In approach 1a, the UE(s) 315 may collect or transfer training data to a data collection entity (e.g., device(s) B 320 or an over-the-top (OTT) server(s), among other examples) outside of an MNO for AI/ML model training.

Approach 1b may include data collection with a data collection server within an MNO. In approach 1b, the device(s) A 310 may send a data collection configuration(s) to the UE(s) 315. The UE(s) 315 may collect training data or transfer training data to device(s) A 310 (e.g., server(s)) for data collection for AI/ML model training (inside an MNO). In some aspects, a vendor-specific transparent container may be provisioned for data communication. The training data may be communicated via a user plane-based transport between the UE(s) 315 and device(s) A 310 (e.g., server(s)). The device(s) A 310 may initialize or terminate data collection procedures or the reporting of collected data. In some examples, the device(s) A 310 may store or anonymize collected data.

In some aspects, the training data may be transferred from the device(s) A 310 for data collection for AI/ML model training to device(s) B 320 (e.g., an OTT server(s) outside the MNO). For instance, the training data may be sent to the device(s) B 320 (e.g., UE vendor cloud) for AI/ML model training. In some examples, a data collection architecture may be utilized, end-to-end configuration between UE vendors and field UEs may not be utilized, the MNO may not provide storage per UE vendor, data collection configuration may be transparent to the network node 305 (e.g., gNB) and core network functions, or any combination thereof.

In approach 2, data collection may be performed with a core network function (e.g., device(s) A 310). The device(s) B 320 may send a data collection configuration(s) (e.g., UE vendor specific configuration) to the device(s) A 310. The device(s) A 310 may send a data collection configuration(s) to the UE(s) 315. The UE(s) 315 may collect training data or transfer the training data to the device(s) A 310 (e.g., core network function(s) or entity(ies)). In some aspects, a vendor-specific transparent container may be provisioned for data communication. The training data may be communicated via a control plane-based transport between the UE(s) 315 and device(s) A 310 (e.g., core network function(s)). Additionally, or alternatively, a user plane-based transport may be utilized or provided between the UE(s) 315 and the device(s) A 310 (e.g., core network function) to communicate the training data. The device(s) A 310 may initialize or terminate data collection procedures or the reporting of collected data. In some examples, the device(s) A 310 may store or anonymize collected data.

The device(s) A 310 (e.g., core network entity(ies)) may transfer the training data to the device(s) B 320 (e.g., OTT server(s)) for data collection for AI/ML model training. In some examples, AI/ML model training may be performed by the device(s) A 310 (e.g., the MNO network), data collection configuration may be transparent to the network node 305 (e.g., gNB), or any combination thereof. In some aspects, vendor-specific configuration may be transparent to one or more core network functions. Training data may be sent from the device(s) A 310 (e.g., core network function(s)) to the device(s) B 320 (e.g., data collection server(s) or OTT server(s)) for AI/ML model training (if provisioned, for instance).

In approach 3, a UE(s) 315 may collect training data and transfer the training data to an OAM device(s) (e.g., device(s) A 310). The device(s) B 320 may send a data collection configuration(s) (e.g., UE vendor specific configuration) to the device(s) A 310. The device(s) A 310 may send a data collection configuration(s) to the network node(s) 305, and the network node(s) 305 may send a data collection configuration(s) to the UE(s) 315. For example, the device(s) A 310 (e.g., OAM device(s)) may configure the network node(s) 305 (e.g., gNB(s)) with a data collection configuration(s). The network node(s) 305 (e.g., gNB(s)) may initialize or terminate data collection procedures or the reporting of collected data.

The UE(s) 315 may collect training data or transfer the training data to the device(s) A 310 (e.g., OAM device(s)) via the network node(s) 305. In some aspects, a vendor-specific transparent container may be provisioned for data communication. The training data may be communicated via a control plane-based transport between the UE(s) 315 and device(s) A 310 (e.g., core network function(s) or OAM device(s)). Additionally, or alternatively, a user plane-based transport may be utilized or provided between the UE(s) 315 and the device(s) A 310 (e.g., core network function) to communicate the training data. In some examples, the device(s) A 310 (e.g., OAM device(s)) may store or anonymize collected data.

The device(s) A 310 (e.g., core network entity(ies)) may transfer the training data to the device(s) B 320 (e.g., OTT server(s)) for data collection for AI/ML model training. For instance, the OAM device(s) may transfer the training data to the device(s) B 320 (e.g., OTT server) for data collection for AI/ML model training at the device(s) B 320. In some examples, AI/ML model training may be performed by the device(s) A 310 (e.g., the MNO network), data collection configuration may be non-transparent to the network node(s) 305 (e.g., gNB(s)), or any combination thereof. In some aspects, vendor-specific configuration may be transparent to the network node(s) 305 (e.g., gNB(s)) or one or more core network functions. Training data may be sent from the device(s) A 310 (e.g., core network function(s)) to the device(s) B 320 (e.g., data collection server(s) or OTT server(s)) for AI/ML model training (if provisioned, for instance).

In accordance with some of the techniques described herein, the UE(s) 315 may send capability information to the network node(s) 305 or to the device(s) A 310. Additionally, or alternatively, the device(s) B 320, the device(s) A 310, or the network node(s) 305 may send configuration information to the UE(s) 315. The UE(s) 315 may collect training data for training one or more AI/ML models or corresponding to one or more prediction functionalities. The UE(s) 315, network node(s) 305, device(s) A 310, or device(s) B 320 may perform AI/ML model training corresponding to one or more prediction functionalities based on training data collected by the UE(s) 315.

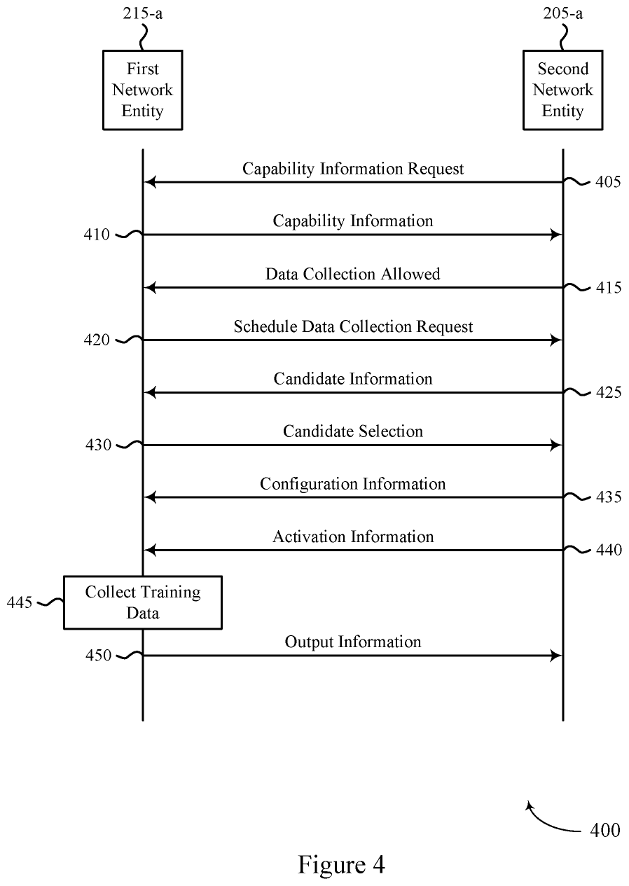

FIG. 4 shows an example of a process flow 400 that supports communications for data collection configurations. The process flow 400 may include a first network entity 215-a, which may be an example of the UE 115, the second network entity 205, the first network entity 215, or the UE(s) 315 described with reference to FIG. 1, FIG. 2 or FIG. 3. The process flow 400 may also include a second network entity 205-a, which may be an example of the network entity 105, the second network entity 205, the first network entity 215, the network node(s) 305, the device(s) A 310, or the device(s) B 320 described with reference to FIG. 1, FIG. 2 or FIG. 3. The process flow 400 (e.g., signaling flow) may illustrate examples of messages exchanged between the first network entity 215-a (e.g., UE) and the second network entity 205-a (e.g., network) for data collection configuration.

In the following description of the process flow 400, the communications between the first network entity 215-a and the second network entity 205-a may be transmitted in the example order shown or in a different order than the example order shown. Additionally, or alternatively, the operations performed by the first network entity 215-a or the second network entity 205-a may be performed in the order shown or in different orders or at different times. One or more operations may be omitted from the process flow 400, or one or more other operations may be added to the process flow 400. Although some operations or signaling may be shown to occur at different times for discussion purposes, these operations may actually occur at the same time or in overlapping time periods in some examples.

At 405, the second network entity 205-a may output (e.g., transmit), or the first network entity 215-a may obtain (e.g., receive), a request for capability information. For instance, the request for the capability information may be communicated as described with reference to FIG. 2.

At 410, the first network entity 215-a may output (e.g., transmit), or the second network entity 205-a may obtain (e.g., receive), capability information. For instance, the capability information may be communicated as described with reference to FIG. 2.

At 415, the second network entity 205-a may output (e.g., transmit), or the first network entity 215-a may obtain (e.g., receive), an indication that data collection is allowed. For instance, the second network entity 205-a may transmit the indication as described with reference to FIG. 2.

At 420, the first network entity 215-a may output (e.g., transmit), or the second network entity 205-a may obtain (e.g., receive), a request to schedule data collection. For instance, the request to schedule data collection may be communicated as described with reference to FIG. 2.

At 425, the second network entity 205-a may output (e.g., transmit), or the first network entity 215-a may obtain (e.g., receive), candidate information. For instance, the second network entity 205-a may transmit the candidate information (e.g., indicative of candidate measurement objects) as described with reference to FIG. 2.

At 430, the first network entity 215-a may output (e.g., transmit), or the second network entity 205-a may obtain (e.g., receive), an indication of one or more selected candidate measurement objects. For instance, the indication of one or more candidate measurement objects may be communicated as described with reference to FIG. 2.

At 435, the second network entity 205-a may output (e.g., transmit), or the first network entity 215-a may obtain (e.g., receive), configuration information. For instance, the second network entity 205-a may transmit the configuration information as described with reference to FIG. 2 or FIG. 3.

At 440, the second network entity 205-a may output (e.g., transmit), or the first network entity 215-a may obtain (e.g., receive), activation information. For instance, the second network entity 205-a may transmit the activation information (e.g., indicative of activation or deactivation of data collection) as described with reference to FIG. 2.

At 445, the first network entity 215-a may collect training data. For instance, the first network entity 205-a may measure one or more signals (from the second network entity 205-a or one or more other network entities or devices) as described with reference to FIG. 2 to collect the training data.

At 450, the first network entity 215-a may output (e.g., transmit), or the second network entity 205-a may obtain (e.g., receive), output information. For instance, the output information may be communicated as described with reference to FIG. 2 or FIG. 3.

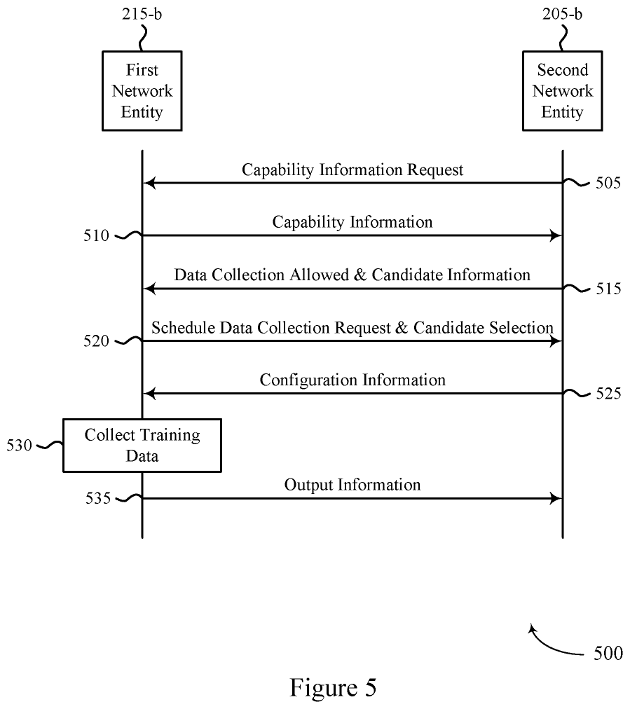

FIG. 5 shows an example of a process flow 500 that supports communications for data collection configurations. The process flow 500 may include a first network entity 215-b, which may be an example of the UE 115, the second network entity 205, the first network entity 215, or the UE(s) 315 described with reference to FIG. 1, FIG. 2 or FIG. 3. The process flow 500 may also include a second network entity 205-b, which may be an example of the network entity 105, the second network entity 205, the first network entity 215, the network node(s) 305, the device(s) A 310, or the device(s) B 320 described with reference to FIG. 1, FIG. 2 or FIG. 3. The process flow 500 (e.g., signaling flow) may illustrate examples of messages exchanged between the first network entity 215-b (e.g., UE) and the second network entity 205-b (e.g., network) for data collection configuration.

In the following description of the process flow 500, the communications between the first network entity 215-b and the second network entity 205-b may be transmitted in the example order shown or in a different order than the example order shown. Additionally, or alternatively, the operations performed by the first network entity 215-b or the second network entity 205-b may be performed in the order shown or in different orders or at different times. One or more operations may be omitted from the process flow 500, or one or more other operations may be added to the process flow 500. Although some operations or signaling may be shown to occur at different times for discussion purposes, these operations may actually occur at the same time or in overlapping time periods in some examples.

At 505, the second network entity 205-b may output (e.g., transmit), or the first network entity 215-b may obtain (e.g., receive), a request for capability information. For instance, the request for the capability information may be communicated as described with reference to FIG. 2.

At 510, the first network entity 215-b may output (e.g., transmit), or the second network entity 205-b may obtain (e.g., receive), capability information. For instance, the capability information may be communicated as described with reference to FIG. 2.

At 515, the second network entity 205-b may output (e.g., transmit), or the first network entity 215-b may obtain (e.g., receive), an indication that data collection is allowed and candidate information. For instance, the second network entity 205-b may transmit the indication and candidate information (e.g., in one message) as described with reference to FIG. 2.

At 520, the first network entity 215-b may output (e.g., transmit), or the second network entity 205-b may obtain (e.g., receive), a request to schedule data collection and an indication of one or more selected candidate measurement objects. For instance, the request to schedule data collection and the indication of one or more selected candidate measurement objects may be communicated (e.g., in one message) as described with reference to FIG. 2.

At 525, the second network entity 205-b may output (e.g., transmit), or the first network entity 215-b may obtain (e.g., receive), configuration information. For instance, the second network entity 205-b may transmit the configuration information as described with reference to FIG. 2 or FIG. 3.

At 530, the first network entity 215-b may collect training data. For instance, the first network entity 205-b may measure one or more signals (from the second network entity 205-b or one or more other network entities or devices) as described with reference to FIG. 2 to collect the training data.

At 535, the first network entity 215-b may output (e.g., transmit), or the second network entity 205-b may obtain (e.g., receive), output information. For instance, the output information may be communicated as described with reference to FIG. 2 or FIG. 3.

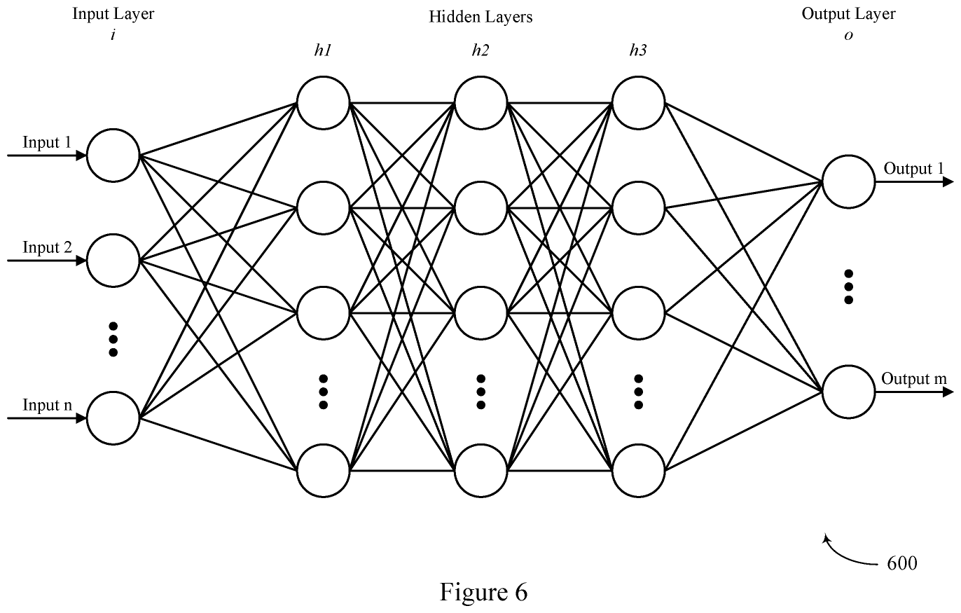

FIG. 6 shows an example of a node diagram 600 that supports communications for data collection configurations. AI models are programmatic or algorithmic structures that simulate intelligent behavior. Machine learning models may be examples of AI models. Machine learning models are programmatic or algorithmic structures that may be trained to infer or predict an output based on an input. For example, a machine learning model may be trained using training input data and ground truth data.

Machine learning models may be categorized as unsupervised or supervised. Unsupervised learning may be utilized to draw inferences and find patterns from input data without references to labeled outcomes. Two examples of unsupervised learning models include clustering and dimensionality reduction. Clustering is an unsupervised technique that involves the grouping, or clustering, of data points. Clustering techniques may include k-means clustering, hierarchical clustering, mean shift clustering, and density-based clustering. Dimensionality reduction may be a procedure for reducing a quantity of random variables under consideration by obtaining a set of principal variables. Dimensionality reduction may reduce the dimension of a feature set or reduce a quantity of features). Some dimensionality reduction techniques may be categorized as feature elimination or feature extraction. One example of dimensionality reduction may be referred to as principal component analysis (PCA). PCA may involve projecting higher dimensional data (e.g., three dimensions) to a lower-dimensional space (e.g., two dimensions), which may result in a lower dimension of data (e.g., two dimensions instead of three dimensions) while maintaining one or more variables in the model.

Supervised learning involves learning a function that maps an input to an output based on associated inputs and outputs. For instance, supervised learning may be utilized to draw inferences and find patterns from input data based on labeled data (e.g., training input data with associated ground truth data). A supervised model may sub-categorized as a regression or classification model. Regression models may provide continuous outputs. One example of a regression model is a linear regression, which may determine a line that fits (e.g., best fits) input data. Extensions of linear regression include multiple linear regression (e.g., finding a plane of best fit) and polynomial regression (e.g., finding a curve of best fit).

In classification models, the output may be discrete. One example of a classification model is logistic regression. Logistic regression may be similar to linear regression, but may be used to model a probability for a finite quantity of outcomes. For example, a logistic regression may be utilized such that the output values may be between 0 and 1. Another example of a classification model is a support vector machine. For two classes of data, for example, a support vector machine may determine a hyperplane or a boundary between the two classes of data that maximizes a margin between the two classes. For instance, many planes may separate two classes, while one plane may maximize the margin or distance between the classes. Another example of a classification model is Naïve Bayes, which is based on Bayes Theorem.

Other examples of classification models include decision tree models, random forest models, and neural network models, where an output may be discrete. In a decision tree model, a tree structure is defined with multiple nodes. Decisions may be used to move from a root node at the top of the decision tree to a leaf node (e.g., a node without a child node) at the bottom of the decision tree. A higher quantity of nodes in the decision tree model may correlate with higher decision accuracy.

Random forest models may utilize ensemble learning techniques that build from decision tree models. Random forests involve creating multiple decision trees using bootstrapped datasets of the original data and randomly selecting a subset of variables at each tier of the decision tree. The model may select the mode of all of the predictions of each decision tree. By relying on a “majority wins” model, the risk of error from an individual tree may be reduced.

Another example of a machine learning model is a neural network (NN). A neural network may be a network of functional nodes. Neural networks may utilize one or more input variables to traverse the nodes and generate one or more output variables. For example, a neural network may utilize an input vector to generate an output vector.

The AI model illustrated in FIG. 6 is an example of a neural network. The neural network includes an input layer i that receives n (one or more) inputs (illustrated as “Input 1,” “Input 2,” and “Input n”), one or more hidden layers (illustrated as hidden layers “h1,” “h2,” and “h3”) for processing the inputs from the input layer, and an output layer o that provides m (one or more) outputs (labeled “Output 1” and “Output m”). While examples of quantities of inputs n, hidden layers h, and outputs m are illustrated in FIG. 6, same or different quantities of inputs, hidden layers, or outputs may be utilized in other examples. In some approaches, the hidden layers h may include linear function(s) or activation function(s) that the nodes (illustrated as circles) of each successive hidden layer process from the nodes of the previous hidden layer.

In some aspects, the AI model illustrated in FIG. 6 or another AI model may be trained in accordance with one or more training techniques. In some examples of the training techniques described herein, one or more AI models (e.g., implemented by one or more devices) may be trained based on training input data (e.g., measurements of reference signals to or from one or more UEs) and ground truth data (e.g., measurements or events relative to one or more UEs), thereby enabling later determination of an output (e.g., an inferred or predicted measurements or events) when an AI model is executed with runtime input data.

Ground truth data may be data representing a target output associated with training input data. Ground truth data may be generated or observed (e.g., empirical) data. In some examples, ground truth data may indicate one or more observed measurements or events corresponding to training input data. Examples of training input data may include reference signal data (e.g., measurements of a SRS, reference signal of an SSB, CSI-RS, or DMRS, among other examples), signal data (e.g., signal strength data, reference signal received power (RSRP) data, received signal strength indicator (RSSI) data, reference signal received quality (RSRQ) data, signal-to-interference noise ratio (SINR) data, or signal-to-noise ratio (SNR) data, among other examples), channel data (e.g., beam data, channel impulse response (CIR) data or channel estimate data, among other examples), identifier data (e.g., cell ID data or service set identifier (SSID) data, among other examples), or event configuration information (e.g., threshold(s) or trigger times, among other examples), among other examples.

In some examples, ground truth data may indicate one or more measurements or values corresponding to training input data. Examples of ground truth data may include reference signal data (e.g., measurements of a PRS, SRS, reference signal of an SSB, CSI-RS, or DMRS, among other examples), signal data (e.g., signal strength data, RSRP data, RSSI data, RSRQ data, SINR data, or SNR data, among other examples), channel data (e.g., beam data, CIR data, or channel estimate data, among other examples), identifier data (e.g., cell ID data or SSID data, among other examples), or event data (e.g., occurrence of a measurement event, handover, cell switch, or beam switch, among other examples), among other examples.

An AI model (e.g., the AI model illustrated in FIG. 6 or a machine learning model) may be trained by executing the AI model with the training data to produce an output, comparing the output with the ground truth data, and adjusting weights of the AI model to reduce a disparity between the output and the ground truth data. For example, one or more of the nodes or connections of the AI model may have an associated weight that may be adjusted to modify one or more of the outputs. In some approaches, a cost function may be utilized to compare the output with the ground truth data to indicate a cost (e.g., error or disparity). Adjustments to the weights that reduce the cost may be retained, advanced, or increased, while adjustments to the weights that increase the cost may be discarded, avoided, or decreased. Training procedures may be repeated or iterated to improve AI model performance.

Input data (e.g., runtime input data) may be provided to a trained AI model, which may infer or predict an output based on the input data. Some examples of AI models may be trained to infer or predict a measurement or event based on input data (e.g., measurement data). Some examples of AI models may be trained to infer or predict measurements or events based on input data.

Some examples of the techniques described herein may be performed in conjunction with one or more of the AI models described with reference to FIG. 6. For instance, an AI model may be trained to perform one or more prediction functionalities as described with reference to FIG. 2.

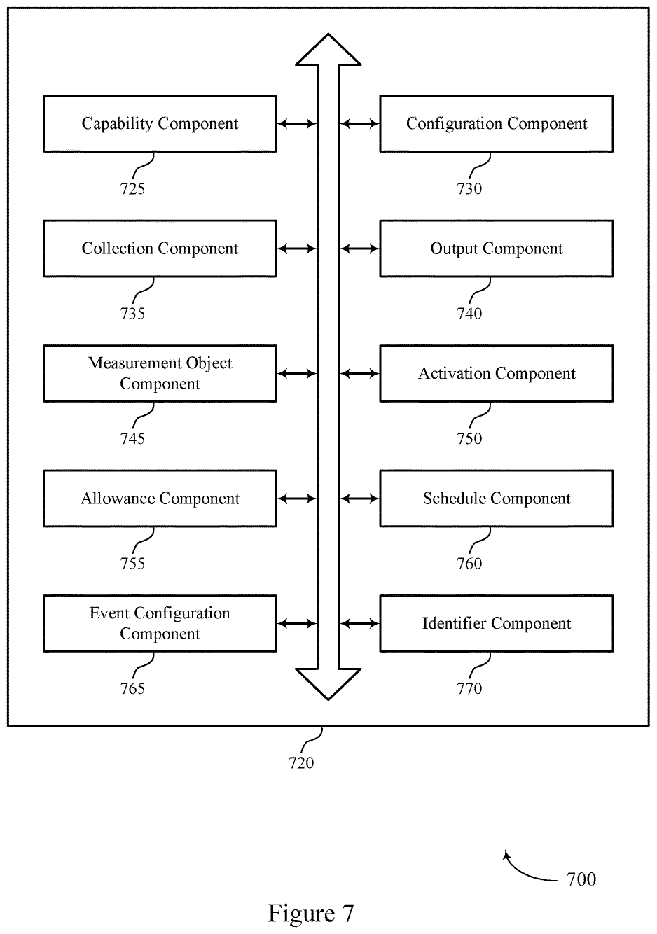

FIG. 7 shows a block diagram 700 of a processing system 720 that supports communications for data collection configurations in accordance with one or more aspects of the present disclosure. The processing system 720 may be an example of aspects of a first network entity as described with reference to FIGS. 1 through 6. The processing system 720, or various components thereof, may be an example of means for performing (e.g., to cause the processing system 720 to perform) various aspects of communications for data collection configurations as described herein. For example, the processing system 720 may include a capability component 725, a configuration component 730, a collection component 735, an output component 740, a measurement object component 745, an activation component 750, an allowance component 755, a schedule component 760, an event configuration component 765, an identifier component 770, or any combination thereof. Each of these components, or components or subcomponents thereof (e.g., one or more processors, one or more memories), may communicate, directly or indirectly, with one another (e.g., via one or more buses).

The capability component 725 is capable of, configured to, or operable to support a means for transmitting capability information indicative of a capability of the first network entity to collect training data for one or more AI/ML models, where the capability information is indicative of the capability to collect training data for one or more prediction functionalities corresponding to the one or more AI/ML models. The configuration component 730 is capable of, configured to, or operable to support a means for receiving configuration information indicative of one or more measurement objects for which the first network entity is to collect the training data for at least one prediction functionality of the one or more prediction functionalities, where the configuration information is based on the capability information. The collection component 735 is capable of, configured to, or operable to support a means for collecting the training data based on measurement of the one or more measurement objects indicated via the configuration information. The output component 740 is capable of, configured to, or operable to support a means for transmitting output information that is based on the training data.

In some examples, the capability component 725 is capable of, configured to, or operable to support a means for receiving a request for the capability information, where transmission of the capability information is based on the request for the capability information.

In some examples, the measurement object component 745 is capable of, configured to, or operable to support a means for receiving candidate information indicative of candidate measurement objects. In some examples, the measurement object component 745 is capable of, configured to, or operable to support a means for transmitting an indication of one or more selected candidate measurement objects from the candidate measurement objects, where the one or more measurement objects indicated in the configuration information are based on the indication.

In some examples, the measurement object component 745 is capable of, configured to, or operable to support a means for transmitting an indication that at least one measurement object of the one or more measurement objects cannot be measured.

In some examples, the activation component 750 is capable of, configured to, or operable to support a means for receiving activation information indicative that data collection for the at least one prediction functionality is activated.

In some examples, the activation component 750 is capable of, configured to, or operable to support a means for transmitting a request to activate data collection for the at least one prediction functionality of the one or more prediction functionalities, where the request indicates one or more resources for measurement, the activation information indicates at least one resource of the one or more resources for measurement, and the activation information is received based on the request to activate data collection.

In some examples, the allowance component 755 is capable of, configured to, or operable to support a means for receiving an indication that collection of the training data is allowed for the at least one prediction functionality of the one or more prediction functionalities.

In some examples, the identifier component 770 is capable of, configured to, or operable to support a means for receiving AI/ML model information that is indicative of an identifier that corresponds to at least one AI/ML model of the one or more AI/ML models and for which collection of the training data is allowed.

In some examples, the schedule component 760 is capable of, configured to, or operable to support a means for transmitting a request to schedule data collection.

In some examples, the one or more prediction functionalities include AI/ML-based RRM measurement prediction, AI/ML-based cell measurement prediction, AI/ML-based beam measurement prediction, AI/ML-based measurement event prediction, AI/ML-based beam management prediction, AI/ML-based temporal measurement prediction, AI/ML-based spatial measurement prediction, AI/ML-based frequency measurement prediction, or any combination thereof.

In some examples, the event configuration component 765 is capable of, configured to, or operable to support a means for receiving event configuration information, where the output information includes the event configuration information.

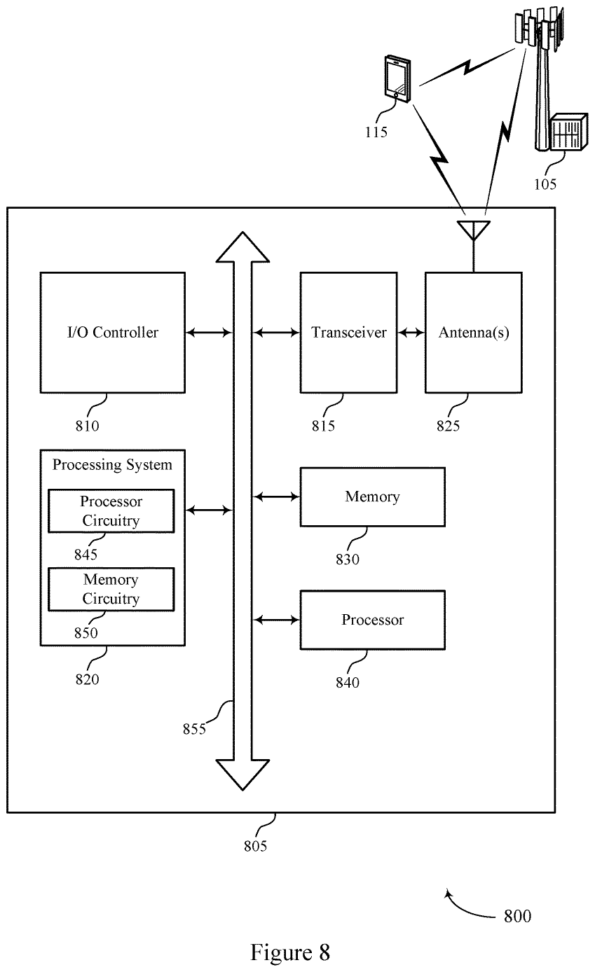

FIG. 8 shows an example of a system 800 including a device 805 that supports communications for data collection configurations. The device 805 may include a processing system 820, an I/O controller, such as an I/O controller 810, a transceiver 815, one or more antennas 825, at least one memory 830, at least one processor 840, a processor circuitry 845, and a memory circuitry 850. Components of the device 805 may be coupled (such as operatively, communicatively, functionally, electronically, electrically, in electronic communication) via a bus 855.

The transceiver 815 may support bi-directional communication via antenna(s) 825, and may support transmission operations, reception operations, or both, as described herein. The transceiver 815 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 805). The transceiver 815 may modulate symbols and provide the modulated symbols to antenna(s) 825 for transmission, and demodulate symbols from signals received using antenna(s) 825.

The processor 840 may be a general-purpose processing component that supports various operations (such as applications) of the device 805. The memory 830 may be a general-purpose storage component that stores code executable by the processor 840. Such code may include instructions that, when executed by the processor 840, cause the device 805 to perform various functions (such as to support an application of the device 805). The I/O controller 810 may manage inputs and outputs for the device 805, may manage peripherals not integrated into the device 805, or may represent a physical connection (such as port) to an external peripheral. The processor 840 may interact with a modem, a keyboard, a mouse, a touchscreen, or other device (such as via I/O controller 810). In some implementations, a user may interact with the device 805 via the I/O controller 810 or via hardware components controlled by the I/O controller 810.

For example, the processing system 820 is capable of, configured to, or operable to support a means for transmitting capability information indicative of a capability of the first network entity to collect training data for one or more AI/ML models, where the capability information is indicative of the capability to collect training data for one or more prediction functionalities corresponding to the one or more AI/ML models. The processing system 820 is capable of, configured to, or operable to support a means for receiving configuration information indicative of one or more measurement objects for which the first network entity is to collect the training data for at least one prediction functionality of the one or more prediction functionalities, where the configuration information is based on the capability information. The processing system 820 is capable of, configured to, or operable to support a means for collecting the training data based on measurement of the one or more measurement objects indicated via the configuration information. The processing system 820 is capable of, configured to, or operable to support a means for transmitting output information that is based on the training data.

By including or configuring the processing system 820 for operation in the device 805 as described herein, may support techniques for improved communication reliability, reduced latency, reduced power consumption, more efficient utilization of communication resources, improved coordination between devices, longer battery life, or improved utilization of processing capability.

The processing system 820 may be an example of a processing system 140 or a processing system 720. For example, the processing system 820 may include processor circuitry 845 and memory circuitry 850 that stores code, and may be configured to cause the device 805 to perform operations that support communications for data collection configurations. Although the processing system 820 is illustrated as a separate component, which may involve a separate chip, chipset, or other module, in some implementations, one or more functions described with reference to the processing system 820 may be supported by or performed by a transceiver 815, antenna(s) 825, a processor 840, memory 830, or any combination thereof, such that a processing system 820 may include one or more of a transceiver 815, antenna(s) 825, a processor 840, memory 830, or any combination thereof.

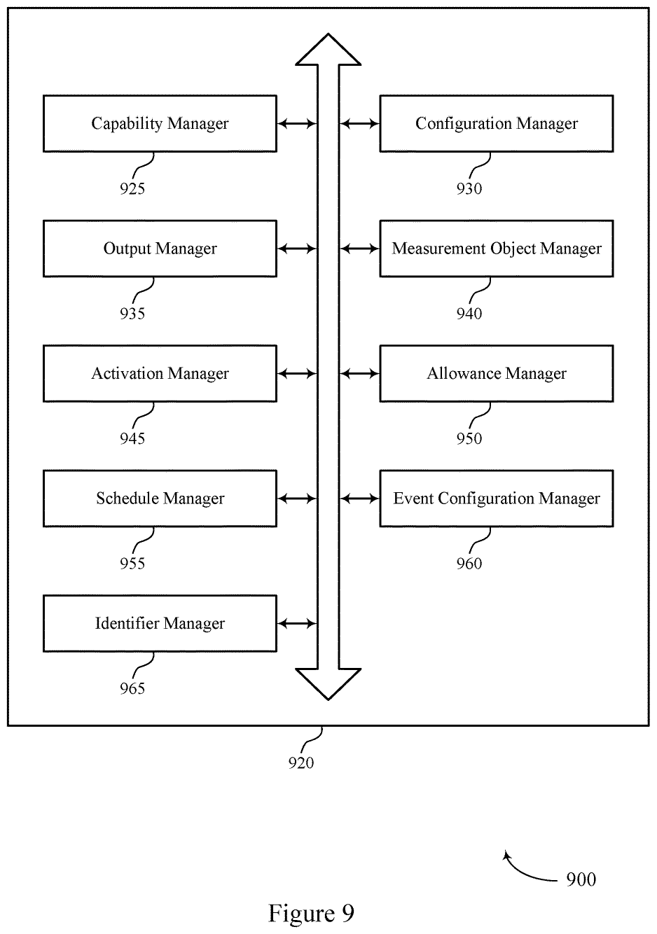

FIG. 9 shows a block diagram 900 of a processing system 920 that supports communications for data collection configurations in accordance with one or more aspects of the present disclosure. The processing system 920 may be an example of aspects of a first network entity as described with reference to FIGS. 1 through 6. The processing system 920, or various components thereof, may be an example of means for performing (e.g., to cause the processing system 920 to perform) various aspects of communications for data collection configurations as described herein. For example, the processing system 920 may include a capability manager 925, a configuration manager 930, an output manager 935, a measurement object manager 940, an activation manager 945, an allowance manager 950, a schedule manager 955, an event configuration manager 960, an identifier manager 965, or any combination thereof. Each of these components, or components or subcomponents thereof (e.g., one or more processors, one or more memories), may communicate, directly or indirectly, with one another (e.g., via one or more buses).

The capability manager 925 is capable of, configured to, or operable to support a means for receiving capability information indicative of a capability of a second network entity to collect training data for one or more AI/ML models, where the capability information is indicative of the capability to collect training data for one or more prediction functionalities corresponding to the one or more AI/ML models. The configuration manager 930 is capable of, configured to, or operable to support a means for transmitting configuration information indicative of one or more measurement objects for which the second network entity is to collect the training data for at least one prediction functionality of the one or more prediction functionalities, where the configuration information is based on the capability information. The output manager 935 is capable of, configured to, or operable to support a means for receiving output information that is based on the training data.

In some examples, the capability manager 925 is capable of, configured to, or operable to support a means for transmitting a request for the capability information, where transmission of the capability information is based on the request for the capability information.

In some examples, the measurement object manager 940 is capable of, configured to, or operable to support a means for transmitting candidate information indicative of candidate measurement objects. In some examples, the measurement object manager 940 is capable of, configured to, or operable to support a means for receiving an indication of one or more selected candidate measurement objects, where the one or more measurement objects indicated in the configuration information are based on the indication.

In some examples, the measurement object manager 940 is capable of, configured to, or operable to support a means for receiving an indication that at least one measurement object of the one or more measurement objects cannot be measured.

In some examples, the activation manager 945 is capable of, configured to, or operable to support a means for transmitting activation information indicative that data collection for the at least one prediction functionality is activated.

In some examples, the activation manager 945 is capable of, configured to, or operable to support a means for receiving a request to activate data collection for the at least one prediction functionality of the one or more prediction functionalities, where the request indicates one or more resources for measurement, the activation information indicates at least one resource of the one or more resources for measurement, and the activation information is transmitted based on the request to activate data collection.

In some examples, the allowance manager 950 is capable of, configured to, or operable to support a means for transmitting an indication that collection of the training data is allowed for the at least one prediction functionality of the one or more prediction functionalities.

In some examples, the identifier manager 965 is capable of, configured to, or operable to support a means for transmitting AI/ML model information that is indicative of an identifier that corresponds to at least one AI/ML model of the one or more AI/ML models and for which collection of the training data is allowed.

In some examples, the schedule manager 955 is capable of, configured to, or operable to support a means for receiving a request to schedule data collection.

In some examples, the one or more prediction functionalities include AI/ML-based RRM measurement prediction, AI/ML-based cell measurement prediction, AI/ML-based beam measurement prediction, AI/ML-based measurement event prediction, AI/ML-based beam management prediction, AI/ML-based temporal measurement prediction, AI/ML-based spatial measurement prediction, AI/ML-based frequency measurement prediction, or any combination thereof.

In some examples, the event configuration manager 960 is capable of, configured to, or operable to support a means for transmitting event configuration information, where the output information that is based on the training data for the one or more AI/ML models includes the event configuration information.

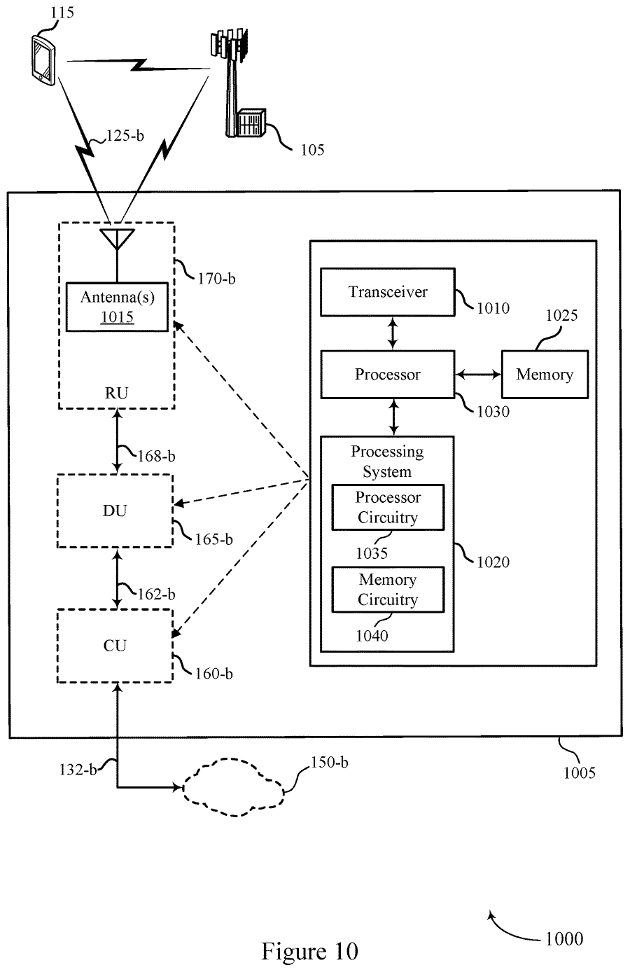

FIG. 10 shows an example of a system 1000 including a device 1005 that supports communications for data collection configurations. The device 1005 may include a processing system 1020, a transceiver 1010, one or more antennas 1015, at least one memory 1025, at least one processor 1030, a processor circuitry 1035, and a memory circuitry 1040. Components of the device 1005 may be coupled (such as operatively, communicatively, functionally, electronically, electrically, in electronic communication) via one or more buses, wired links or wireless links.

The transceiver 1010 may communicate bi-directionally with another transceiver via wired or wireless links, and may support transmission operations, reception operations, or both, as described herein. The transceiver 1010 may include a modem to modulate and demodulate signals, to provide the modulated signals for transmission (such as via antenna(s) 1015, via a wired interface), and to demodulate received signals (such as received via antenna(s) 1015, received via a wired interface). The transceiver 1010 may be operable to support communication via one or more communication links (such as a communication link 125-b, a backhaul link 132-b, a midhaul link 162-b, fronthaul link 168-b).

The processor 1030 may be a general-purpose processing component that supports various operations (such as applications) of the device 1005. The memory 1025 may be a general-purpose storage component that stores code executable by the processor 1030. Such code may include instructions that, when executed by the processor 1030, cause the device 1005 to perform various functions (such as to support an application of the device 1005).

For examples in which the device 1005 is a network entity 105 in a disaggregated architecture, one or more components of the device 1005 may be located at one or more of a CU 160-b, a DU 165-b, or an RU 170-b, one or more of which may include aspects of the processing system 1020, the processor 1030, the memory 1025, or the transceiver 1010. Functions of the device 1005 may be performed at different components or an operation may be divided between different components (such as different functions being supported by aspects of the CU 160-b, the DU 165-b, or the RU 170-b, the transceiver 1010, the processor 1030, the memory 1025, the processing system 1020, or any combination thereof). For example, the processing system 1020 may be a component of one or more of the CU 160-b, the DU 165-b, or the RU 170-b. In some examples, interfaces between components of device 1005 (such as CU 160-b, DU 165-b, RU 170-b) may support communication at a protocol layer or between protocol layers of a protocol stack.

For example, the processing system 1020 is capable of, configured to, or operable to support a means for receiving capability information indicative of a capability of a second network entity to collect training data for one or more AI/ML models, where the capability information is indicative of the capability to collect training data for one or more prediction functionalities corresponding to the one or more AI/ML models. The processing system 1020 is capable of, configured to, or operable to support a means for transmitting configuration information indicative of one or more measurement objects for which the second network entity is to collect the training data for at least one prediction functionality of the one or more prediction functionalities, where the configuration information is based on the capability information. The processing system 1020 is capable of, configured to, or operable to support a means for receiving output information that is based on the training data.

By including or configuring the processing system 1020 for operation in the device 1005 as described herein, may support techniques for improved communication reliability, reduced latency, reduced power consumption, more efficient utilization of communication resources, improved coordination between devices, longer battery life, or improved utilization of processing capability.

In some examples, the processing system 1020 may manage aspects of communication with the core network 150-b (such as via a backhaul link 132). For example, the processing system 1020 may manage the transfer of data communication for UEs 115 with a gateway of the core network 150-b. In some examples, the processing system 1020 may manage communication with one or more other network entities 105 and may include a controller or scheduler for controlling communication with UEs 115 (such as in cooperation with the one or more other network entities 105). In some examples, the processing system 1020 may support an interface (such as X2 interface, Xn interface) to provide communication between network entities 105.

The processing system 1020 may be an example of a processing system 145 or a processing system 920. For example, the processing system 1020 may include processor circuitry 1035 and memory circuitry 1040 that stores code, and the processing system 1020 may be configured to cause the device 1005 to perform operations that support communications for data collection configurations. Although the processing system 1020 is illustrated as a separate component, which may involve a separate chip, chipset, or other module, in some implementations, one or more functions described with reference to the processing system 1020 may be supported by or performed by a transceiver 1010, antenna(s) 1015, a processor 1030, memory 1025, or any combination thereof, such that a processing system 1020 may include one or more of a transceiver 1010, antenna(s) 1015, a processor 1030, memory 1025, or any combination thereof. Further, processor circuitry 1035 and memory circuitry 1040 each may be implemented at the device 1005 in accordance with an aggregated architecture, or the processor circuitry 1035 and the memory circuitry 1040 may be implemented at one or more of a CU 160-b, a DU 165-b, or an RU 170-b in accordance with a disaggregated architecture.

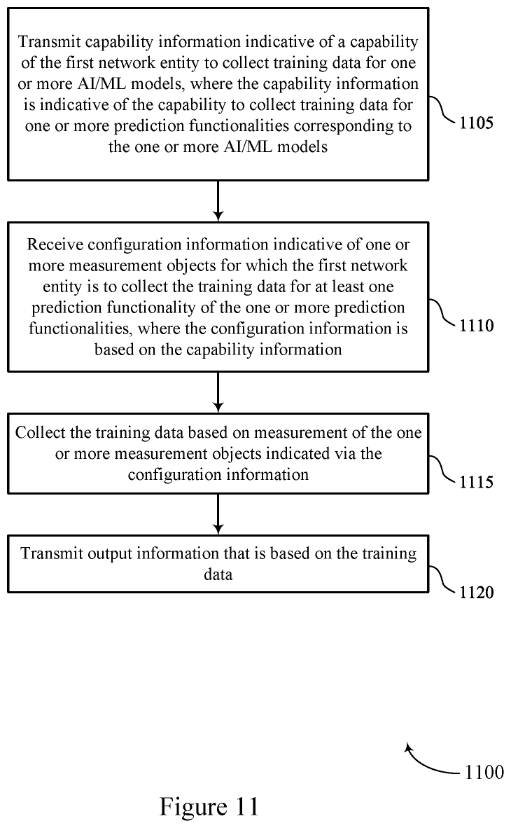

FIG. 11 shows a flowchart illustrating a method 1100 that supports communications for data collection configurations. The operations of the method 1100 may be implemented by a first network entity or its components as described herein. For example, the operations of the method 1100 may be performed by a first network entity as described with reference to FIGS. 1 through 8. In some examples, a first network entity may execute a set of instructions to control the functional elements of the first network entity to perform the described functions. Additionally, or alternatively, the first network entity may perform aspects of the described functions using special-purpose hardware.

At 1105, the method may include transmitting capability information indicative of a capability of the first network entity to collect training data for one or more AI/ML models, where the capability information is indicative of the capability to collect training data for one or more prediction functionalities corresponding to the one or more AI/ML models. In some examples, aspects of the operations of 1105 may be performed by a capability component 725.

At 1110, the method may include receiving configuration information indicative of one or more measurement objects for which the first network entity is to collect the training data for at least one prediction functionality of the one or more prediction functionalities, where the configuration information is based on the capability information. In some examples, aspects of the operations of 1110 may be performed by a configuration component 730.

At 1115, the method may include collecting the training data based on measurement of the one or more measurement objects indicated via the configuration information. In some examples, aspects of the operations of 1115 may be performed by a collection component 735.

At 1120, the method may include transmitting output information that is based on the training data. In some examples, aspects of the operations of 1120 may be performed by an output component 740.

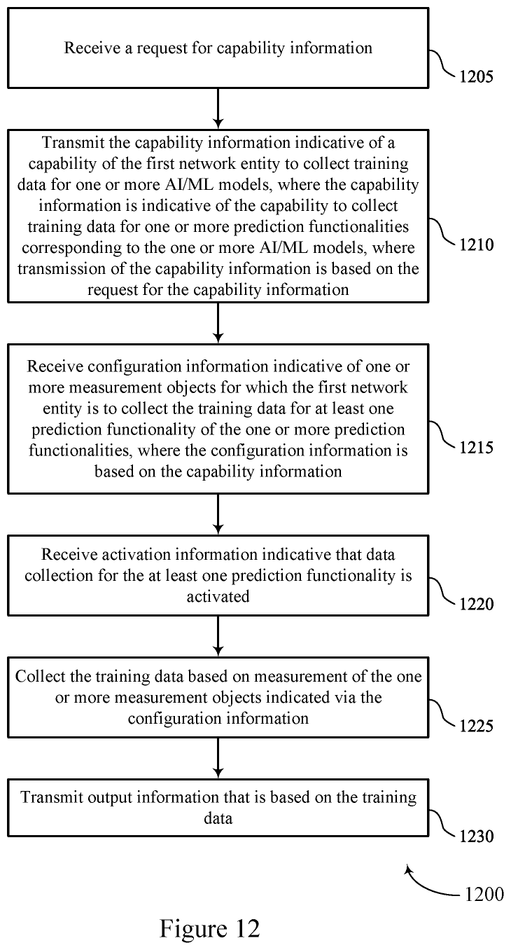

FIG. 12 shows a flowchart illustrating a method 1200 that supports communications for data collection configurations. The operations of the method 1200 may be implemented by a first network entity or its components as described herein. For example, the operations of the method 1200 may be performed by a first network entity as described with reference to FIGS. 1 through 8. In some examples, a first network entity may execute a set of instructions to control the functional elements of the first network entity to perform the described functions. Additionally, or alternatively, the first network entity may perform aspects of the described functions using special-purpose hardware.

At 1205, the method may include receiving a request for capability information. In some examples, aspects of the operations of 1205 may be performed by a capability component 725.

At 1210, the method may include transmitting the capability information indicative of a capability of the first network entity to collect training data for one or more AI/ML models, where the capability information is indicative of the capability to collect training data for one or more prediction functionalities corresponding to the one or more AI/ML models, where transmission of the capability information is based on the request for the capability information. In some examples, aspects of the operations of 1210 may be performed by a capability component 725.

At 1215, the method may include receiving configuration information indicative of one or more measurement objects for which the first network entity is to collect the training data for at least one prediction functionality of the one or more prediction functionalities, where the configuration information is based on the capability information. In some examples, aspects of the operations of 1215 may be performed by a configuration component 730.

At 1220, the method may include receiving activation information indicative that data collection for the at least one prediction functionality is activated. In some examples, aspects of the operations of 1220 may be performed by an activation component 750.

At 1225, the method may include collecting the training data based on measurement of the one or more measurement objects indicated via the configuration information. In some examples, aspects of the operations of 1225 may be performed by a collection component 735.

At 1230, the method may include transmitting output information that is based on the training data. In some examples, aspects of the operations of 1230 may be performed by an output component 740.

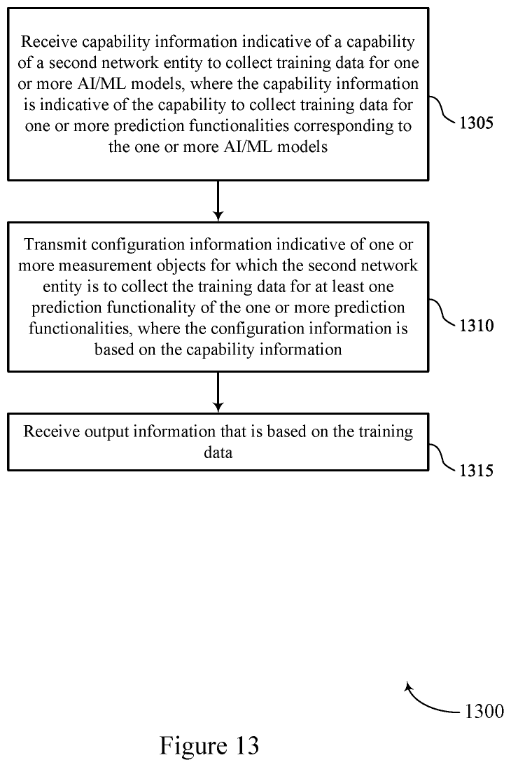

FIG. 13 shows a flowchart illustrating a method 1300 that supports communications for data collection configurations. The operations of the method 1300 may be implemented by a first network entity or its components as described herein. For example, the operations of the method 1300 may be performed by a first network entity as described with reference to FIGS. 1 through 6 and 9 and 10. In some examples, a first network entity may execute a set of instructions to control the functional elements of the first network entity to perform the described functions. Additionally, or alternatively, the first network entity may perform aspects of the described functions using special-purpose hardware.

At 1305, the method may include receiving capability information indicative of a capability of a second network entity to collect training data for one or more AI/ML models, where the capability information is indicative of the capability to collect training data for one or more prediction functionalities corresponding to the one or more AI/ML models. In some examples, aspects of the operations of 1305 may be performed by a capability manager 925.

At 1310, the method may include transmitting configuration information indicative of one or more measurement objects for which the second network entity is to collect the training data for at least one prediction functionality of the one or more prediction functionalities, where the configuration information is based on the capability information. In some examples, aspects of the operations of 1310 may be performed by a configuration manager 930.

At 1315, the method may include receiving output information that is based on the training data. In some examples, aspects of the operations of 1315 may be performed by an output manager 935.

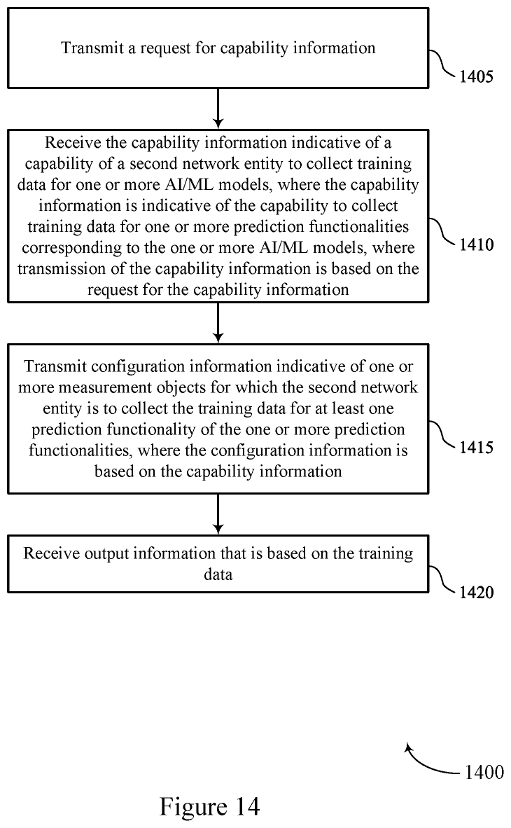

FIG. 14 shows a flowchart illustrating a method 1400 that supports communications for data collection configurations. The operations of the method 1400 may be implemented by a first network entity or its components as described herein. For example, the operations of the method 1400 may be performed by a first network entity as described with reference to FIGS. 1 through 6 and 9 and 10. In some examples, a first network entity may execute a set of instructions to control the functional elements of the first network entity to perform the described functions. Additionally, or alternatively, the first network entity may perform aspects of the described functions using special-purpose hardware.

At 1405, the method may include transmitting a request for capability information. In some examples, aspects of the operations of 1405 may be performed by a capability manager 925.

At 1410, the method may include receiving capability information indicative of a capability of a second network entity to collect training data for one or more AI/ML models, where the capability information is indicative of the capability to collect training data for one or more prediction functionalities corresponding to the one or more AI/ML models, where transmission of the capability information is based on the request for the capability information. In some examples, aspects of the operations of 1410 may be performed by a capability manager 925.

At 1415, the method may include transmitting configuration information indicative of one or more measurement objects for which the second network entity is to collect the training data for at least one prediction functionality of the one or more prediction functionalities, where the configuration information is based on the capability information. In some examples, aspects of the operations of 1415 may be performed by a configuration manager 930.

At 1420, the method may include receiving output information that is based on the training data. In some examples, aspects of the operations of 1420 may be performed by an output manager 935.

Implementation examples are described in the following numbered clauses:

Aspect 1: A method of wireless communication performed by a first network entity, comprising: transmitting capability information indicative of a capability of the first network entity to collect training data for one or more AI/ML models, wherein the capability information is indicative of the capability to collect training data for one or more prediction functionalities corresponding to the one or more AI/ML models; receiving configuration information indicative of one or more measurement objects for which the first network entity is to collect the training data for at least one prediction functionality of the one or more prediction functionalities, wherein the configuration information is based on the capability information; collecting the training data based on measurement of the one or more measurement objects indicated via the configuration information; and transmitting output information that is based on the training data.

Aspect 2: The method of aspect 1, further comprising: receiving a request for the capability information, wherein transmission of the capability information is based on the request for the capability information.

Aspect 3: The method of any of aspects 1 through 2, further comprising: receiving candidate information indicative of candidate measurement objects; and transmitting an indication of one or more selected candidate measurement objects from the candidate measurement objects, wherein the one or more measurement objects indicated in the configuration information are based on the indication.

Aspect 4: The method of any of aspects 1 through 3, further comprising: transmitting an indication that at least one measurement object of the one or more measurement objects cannot be measured.

Aspect 5: The method of any of aspects 1 through 4, further comprising: receiving activation information indicative that data collection for the at least one prediction functionality is activated.

Aspect 6: The method of aspect 5, further comprising: transmitting a request to activate data collection for the at least one prediction functionality of the one or more prediction functionalities, wherein the request indicates one or more resources for measurement, the activation information indicates at least one resource of the one or more resources for measurement, and the activation information is received based on the request to activate data collection.

Aspect 7: The method of any of aspects 1 through 6, further comprising: receiving an indication that collection of the training data is allowed for the at least one prediction functionality of the one or more prediction functionalities.

Aspect 8: The method of aspect 7, further comprising: receiving AI/ML model information that is indicative of an identifier that corresponds to at least one AI/ML model of the one or more AI/ML models and for which collection of the training data is allowed.

Aspect 9: The method of any of aspects 1 through 8, further comprising: transmitting a request to schedule data collection.

Aspect 10: The method of any of aspects 1 through 9, wherein the one or more prediction functionalities comprise AI/ML-based RRM measurement prediction, AI/ML-based cell measurement prediction, AI/ML-based beam measurement prediction, AI/ML-based measurement event prediction, AI/ML-based beam management prediction, AI/ML-based temporal measurement prediction, AI/ML-based spatial measurement prediction, AI/ML-based frequency measurement prediction, or any combination thereof.

Aspect 11: The method of any of aspects 1 through 10, further comprising: receiving event configuration information, wherein the output information comprises the event configuration information.

Aspect 12: A method of wireless communication performed by a first network entity, comprising: receiving capability information indicative of a capability of a second network entity to collect training data for one or more AI/ML models, wherein the capability information is indicative of the capability to collect training data for one or more prediction functionalities corresponding to the one or more AI/ML models; transmitting configuration information indicative of one or more measurement objects for which the second network entity is to collect the training data for at least one prediction functionality of the one or more prediction functionalities, wherein the configuration information is based on the capability information; and receiving output information that is based on the training data.

Aspect 13: The method of aspect 12, further comprising: transmitting a request for the capability information, wherein transmission of the capability information is based on the request for the capability information.

Aspect 14: The method of any of aspects 12 through 13, further comprising: transmitting candidate information indicative of candidate measurement objects; and receiving an indication of one or more selected candidate measurement objects, wherein the one or more measurement objects indicated in the configuration information are based on the indication.

Aspect 15: The method of any of aspects 12 through 14, further comprising: receiving an indication that at least one measurement object of the one or more measurement objects cannot be measured.

Aspect 16: The method of any of aspects 12 through 15, further comprising: transmitting activation information indicative that data collection for the at least one prediction functionality is activated.

Aspect 17: The method of aspect 16, further comprising: receiving a request to activate data collection for the at least one prediction functionality of the one or more prediction functionalities, wherein the request indicates one or more resources for measurement, the activation information indicates at least one resource of the one or more resources for measurement, and the activation information is transmitted based on the request to activate data collection.

Aspect 18: The method of any of aspects 12 through 17, further comprising: transmitting an indication that collection of the training data is allowed for the at least one prediction functionality of the one or more prediction functionalities.

Aspect 19: The method of aspect 18, further comprising: transmitting AI/ML model information that is indicative of an identifier that corresponds to at least one AI/ML model of the one or more AI/ML models and for which collection of the training data is allowed.

Aspect 20: The method of any of aspects 12 through 19, further comprising: receiving a request to schedule data collection.

Aspect 21: The method of any of aspects 12 through 20, wherein the one or more prediction functionalities comprise AI/ML-based RRM measurement prediction, AI/ML-based cell measurement prediction, AI/ML-based beam measurement prediction, AI/ML-based measurement event prediction, AI/ML-based beam management prediction, AI/ML-based temporal measurement prediction, AI/ML-based spatial measurement prediction, AI/ML-based frequency measurement prediction, or any combination thereof.

Aspect 22: The method of any of aspects 12 through 21, further comprising: transmitting event configuration information, wherein the output information that is based on the training data for the one or more AI/ML models comprises the event configuration information.

Aspect 23: A first network entity comprising a processing system that includes processor circuitry and memory circuitry that stores code, the processing system configured to cause the first network entity to perform a method of any of aspects 1 through 11.

Aspect 24: A first network entity comprising at least one means for performing a method of any of aspects 1 through 11.

Aspect 25: A non-transitory computer-readable medium storing code the code comprising instructions executable by one or more processors to perform a method of any of aspects 1 through 11.

Aspect 26: A first network entity comprising a processing system that includes processor circuitry and memory circuitry that stores code, the processing system configured to cause the first network entity to perform a method of any of aspects 12 through 22.

Aspect 27: A first network entity comprising at least one means for performing a method of any of aspects 12 through 22.

Aspect 28: A non-transitory computer-readable medium storing code the code comprising instructions executable by one or more processors to perform a method of any of aspects 12 through 22.

The methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on An as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.” Additionally, a “set” refers to one or more items unless specifically disclosed differently (e.g., a set of a plurality of items), and a “subset” refers to a non-empty portion that is less than a whole set unless specifically disclosed to the differently (e.g., a subset of zero or more items of the set one or more items).

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A first network entity for wireless communication, comprising:
a processing system configured to:
transmit capability information indicative of a capability of the first network entity to collect training data for one or more artificial intelligence or machine learning (AI/ML) models, wherein the capability information is indicative of the capability to collect training data for one or more prediction functionalities corresponding to the one or more AI/ML models;
receive configuration information indicative of one or more measurement objects for which the first network entity is to collect the training data for at least one prediction functionality of the one or more prediction functionalities, wherein the configuration information is based on the capability information;
collect the training data based on measurement of the one or more measurement objects indicated via the configuration information; and
transmit output information that is based on the training data.

2. The first network entity of claim 1, wherein the processing system is configured to:
receive candidate information indicative of candidate measurement objects; and
transmit an indication of one or more selected candidate measurement objects from the candidate measurement objects, wherein the one or more measurement objects indicated in the configuration information are based on the indication.

3. The first network entity of claim 1, wherein the processing system is configured to:
receive activation information indicative that data collection for the at least one prediction functionality is activated; and
transmit a request to activate data collection for the at least one prediction functionality of the one or more prediction functionalities, wherein the request indicates one or more resources for measurement, the activation information indicates at least one resource of the one or more resources for measurement, and the activation information is received based on the request to activate data collection.

4. The first network entity of claim 1, wherein the processing system is configured to:
receive an indication that collection of the training data is allowed for the at least one prediction functionality of the one or more prediction functionalities.

5. The first network entity of claim 4, wherein the processing system is configured to:
receive AI/ML model information that is indicative of an identifier that corresponds to at least one AI/ML model of the one or more AI/ML models and for which collection of the training data is allowed.

6. The first network entity of claim 1, wherein the processing system is configured to:
transmit a request to schedule data collection.

7. The first network entity of claim 1, wherein the one or more prediction functionalities comprise AI/ML-based radio resource management (RRM) measurement prediction, AI/ML-based cell measurement prediction, AI/ML-based beam measurement prediction, AI/ML-based measurement event prediction, AI/ML-based beam management prediction, AI/ML-based temporal measurement prediction, AI/ML-based spatial measurement prediction, AI/ML-based frequency measurement prediction, or any combination thereof.

8. The first network entity of claim 1, wherein the processing system is configured to:
receive event configuration information, wherein the output information comprises the event configuration information.

9. A first network entity for wireless communication, comprising:
a processing system configured to:
receive capability information indicative of a capability of a second network entity to collect training data for one or more artificial intelligence or machine learning (AI/ML) models, wherein the capability information is indicative of the capability to collect training data for one or more prediction functionalities corresponding to the one or more AI/ML models;
transmit configuration information indicative of one or more measurement objects for which the second network entity is to collect the training data for at least one prediction functionality of the one or more prediction functionalities, wherein the configuration information is based on the capability information; and
receive output information that is based on the training data.

10. The first network entity of claim 9, wherein the processing system is configured to:
transmit a request for the capability information, wherein transmission of the capability information is based on the request for the capability information.

11. The first network entity of claim 9, wherein the processing system is configured to:
transmit candidate information indicative of candidate measurement objects; and
receive an indication of one or more selected candidate measurement objects, wherein the one or more measurement objects indicated in the configuration information are based on the indication.

12. The first network entity of claim 9, wherein the processing system is configured to:
receive an indication that at least one measurement object of the one or more measurement objects cannot be measured.

13. The first network entity of claim 9, wherein the processing system is configured to:
transmit activation information indicative that data collection for the at least one prediction functionality is activated.

14. The first network entity of claim 13, wherein the processing system is configured to:
receive a request to activate data collection for the at least one prediction functionality of the one or more prediction functionalities, wherein the request indicates one or more resources for measurement, the activation information indicates at least one resource of the one or more resources for measurement, and the activation information is transmitted based on the request to activate data collection.

15. The first network entity of claim 9, wherein the processing system is configured to:
transmit an indication that collection of the training data is allowed for the at least one prediction functionality of the one or more prediction functionalities.

16. The first network entity of claim 15, wherein the processing system is configured to:
transmit AI/ML model information that is indicative of an identifier that corresponds to at least one AI/ML model of the one or more AI/ML models and for which collection of the training data is allowed.

17. The first network entity of claim 9, wherein the processing system is configured to:
receive a request to schedule data collection.

18. The first network entity of claim 9, wherein the one or more prediction functionalities comprise AI/ML-based radio resource management (RRM) measurement prediction, AI/ML-based cell measurement prediction, AI/ML-based beam measurement prediction, AI/ML-based measurement event prediction, AI/ML-based beam management prediction, AI/ML-based temporal measurement prediction, AI/ML-based spatial measurement prediction, AI/ML-based frequency measurement prediction, or any combination thereof.

19. The first network entity of claim 9, wherein the processing system is configured to:
transmit event configuration information, wherein the output information that is based on the training data for the one or more AI/ML models comprises the event configuration information.

20. A method of wireless communication performed by a first network entity, comprising:
transmitting capability information indicative of a capability of the first network entity to collect training data for one or more artificial intelligence or machine learning (AI/ML) models, wherein the capability information is indicative of the capability to collect training data for one or more prediction functionalities corresponding to the one or more AI/ML models;
receiving configuration information indicative of one or more measurement objects for which the first network entity is to collect the training data for at least one prediction functionality of the one or more prediction functionalities, wherein the configuration information is based on the capability information;
collecting the training data based on measurement of the one or more measurement objects indicated via the configuration information; and
transmitting output information that is based on the training data.
